(19) United States
(12) Patent Application Publication
(10) Pub. No.: US 2018/0001609 A1
(43) Pub. Date: Jan. 4, 2018

(54) Multilayer, Heat-Shrinkable Film Comprising a Plurality of Microlayers

(71) Applicant: Sealed Air Corporation (US), Charlotte, NC (US)

(72) Inventors: Janet Rivett, Simpsonville, SC (US); Bradley Daley, Inman, SC (US); Greg Harwood, Greenville, SC (US)

(21) Appl. No.: 15/539,852

(22) PCT Filed: Dec. 18, 2015
(86) PCT No.: PCT/US2015/066649

§ 371 Date: Jun. 26, 2017

Related U.S. Application Data
(60) Provisional application No. 62/129,072, filed on Mar. 6, 2015.
(60) Provisional application No. 62/096,684, filed on Dec. 24, 2014.

(51) Int. Cl. B32B 27/32; B32B 27/08

(52) U.S. Cl. CPC B32B 27/325; B32B 27/327; B32B 27/08; B32B 2307/736; B32B 2270/00; B32B 2250/242; B32B 2250/05; B32B 2309/105; B32B 2553/00; B32B 2250/42

(57) ABSTRACT

A multilayer, heat-shrinkable film generally includes at least one bulk layer and a microlayer section comprising a plurality of microlayers. The film has a sufficiently low shrink force to wrap fragile items, such as furnace filters.

### BACKGROUND

The present invention relates to packaging materials of a type employing flexible, polymeric, heat-shrinkable films. More specifically, the invention pertains to multilayer, heat-shrinkable films comprising a plurality of microlayers.

One distinguishing feature of a heat-shrinkable film is the film's ability, upon exposure to a certain temperature, to shrink or, if restrained from shrinking, to generate shrink tension within the film.

The manufacture of shrink films is well known in the art, and may be generally accomplished by extrusion (single layer films) or coextrusion (multi-layer films) of thermoplastic polymeric materials which have been heated to their flow or melting point from an extrusion or coextrusion die, e.g., either in tubular or planer (sheet) form. After a post-extrusion quench to cool, e.g., by water immersion, the relatively thick “tape” extrudate is then reheated to a temperature within its orientation temperature range and stretched to orient or align the crystallites and/or molecules of the material. The orientation temperature range for a given material or materials will vary with the different resinous polymers and/or blends thereof which comprise the material. However, the orientation temperature range for a given thermoplastic material may generally be stated to be below the crystalline melting point of the material but above the second order transition temperature (sometimes referred to as the glass transition point) thereof. Within this temperature range, a film may effectively be oriented.

The terms “orientation” or “oriented” are used herein to generally describe the process step and resultant product characteristics obtained by stretching and immediately cooling a thermoplastic polymeric material which has been heated to a temperature within its orientation temperature range so as to revise the molecular configuration of the material by physical alignment of the crystallites and/or molecules of the material to impart certain mechanical properties to the film such as, for example, shrink tension (ASTM D-2838) and heat-shrinkability (expressed quantitatively as “free shrink” per ASTM D-2732). When the stretching force is applied in one direction, uniaxial orientation results. When the stretching force is applied in two directions, biaxial orientation results. The term oriented is also used herein interchangeably with the term “heat-shrinkable,” with these terms designating a material which has been stretched and set by cooling while substantially retaining its stretched dimensions. An oriented (i.e., heat-shrinkable) material will tend to return to its original unstretched (unextended) dimensions when heated to an appropriate elevated temperature.

Returning to the basic process for manufacturing the film as discussed above, it can be seen that the film, once extruded (or coextruded if it is a multi-layer film) and initially cooled, e.g., by water quenching, is then reheated to within its orientation temperature range and oriented by stretching. The stretching to orient may be accomplished in many ways such as, for example, by the “blown bubble” or “tenter framing” techniques. These processes are well known to those in the art and refer to orientation procedures whereby the material is stretched in the cross or transverse direction (TD) and/or in the longitudinal or machine direction (MD). After being stretched, the film is quickly quenched while substantially retaining its stretched dimensions to rapidly cool the film and thus set or lock-in the oriented (aligned) molecular configuration.

The degree of stretching controls the degree or amount of orientation present in a given film. Greater degrees of orientation are generally evidenced by, for example, increased values of shrink tension and free shrink. That is, generally speaking, for films manufactured from the same material under otherwise similar conditions, those films which have been stretched, e.g. oriented, to a greater extent will exhibit larger values for free shrink and shrink tension.

In many cases, after being extruded but prior to being stretch-oriented, the film is irradiated, normally with electron beams, to induce cross-linking between the polymer chains that make up the film.

After setting the stretch-oriented molecular configuration, the film may then be stored in rolls and utilized to tightly package a wide variety of items. In this regard, the product to be packaged may first be enclosed in the heat shrinkable material by heat sealing the shrink film to itself to form a pouch or bag, then inserting the product therein and closing the bag or pouch by heat sealing or other appropriate means such as, for example, clipping. If the material was manufactured by the “blown bubble” technique, the material may still be in tubular form or it may have been slit and opened up to form a sheet of film material. Alternatively, a sheet of the material may be utilized to over-wrap the product, which may be in a tray.

After the enclosure step, the enclosed product is subjected to elevated temperatures by, for example, passing the enclosed product through a hot air or hot water tunnel. This causes the enclosing film to shrink around the product to produce a tight wrapping that closely conforms to the contour of the product.

The above general outline for the manufacturing and use of heat-shrinkable films is not intended to be all inclusive since such processes are well known to those of ordinary skill in the art. For example, see U.S. Pat. Nos. 3,022,543 and 4,551,380, the entire disclosures of which are hereby incorporated herein by reference.

When a heat-shrinkable film shrinks around a product to produce a tight wrapping that closely conforms to the contour of the product, the film exerts a compressive force on the product, known as a ‘shrink force.’ If the shrink force exceeds the dimensional stabilizing force of the product, the product will become distorted within the package. This is highly undesirable, as it can damage the product, make the product difficult to arrange on a retail display shelf, and render the packaged product aesthetically unappealing and thus un-salable.

Certain shrink-film applications entail the packaging of easily-distortable products, such as furnace filters, thin stacks of paper, etc. In such applications, a very low shrink force is required to prevent the product from becoming distorted or damaged. A sufficiently and consistently low shrink force in heat-shrinkable films has been found to be difficult to achieve.

### SUMMARY OF THE INVENTION

The inventors hereof have discovered that heat-shrinkable films having sufficiently low shrink force to package easily-distortable products may be produced by combining a bulk layer and a microlayer section comprising at least about ten microlayers, wherein:

each of the microlayers and the bulk layer have a thickness, the thickness of any of the microlayers being at least half the thickness of the bulk layer;

the film has a film density of less than or equal to 0.940 g/cc (such as, in some embodiments, less than or equal to about 0.911 g/cc); and the microlayer section comprises a repeating sequence of layers represented by the structure:
A/B,
   wherein,

A represents a microlayer comprising cyclic olefin copolymer or a blend of two or more different polymers, at least one of which is polypropylene, and

B represents a microlayer comprising a polymer or polymer blend having a composition that is different from that of A.

These and other aspects and features of the invention may be better understood with reference to the following description and accompanying drawings.

### BRIEF DESCRIPTION OF THE DRAWINGS

FIG. 1 is a schematic view of a system 10 in accordance with the present invention for coextruding a multilayer film;

FIG. 2 is a cross-sectional view of the die 12 shown in FIG. 1;

FIG. 3 is a plan view one of the microlayer plates 48 in die 12;

FIG. 4 is a cross-sectional view of the microlayer plate 48 shown in FIG. 3;

FIG. 5 is a magnified, cross-sectional view of die 12, showing the combined flows from the microlayer plates 48 and distribution plates 32;

FIG. 6 is a cross-sectional view of a multilayer, heat-shrinkable film, which may be produced from die 12 as shown in FIG. 2; and

FIG. 7 is a cross-sectional view of an alternative multilayer, heat-shrinkable film, which may also be produced from die 12 as shown in FIG. 2.

### DETAILED DESCRIPTION OF THE INVENTION

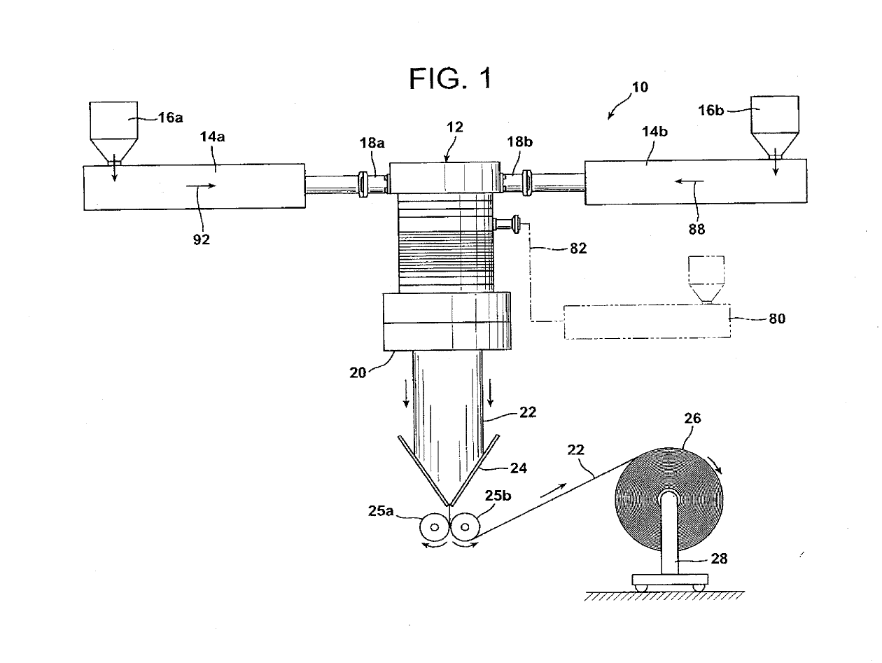

FIG. 1 schematically illustrates a system 10, which may be utilized to coextrude a plurality of fluid layers and thereby form a multilayer, heat-shrinkable film in accordance with the present invention. Such fluid layers typically comprise fluidized polymeric layers, which are in a fluid state by virtue of being molten, i.e., maintained at a temperature above the melting point of the polymer(s) used in each layer.

System 10 generally includes a die 12 and one or more extruders 14a and 14b in fluid communication with the die 12 to supply one or more fluidized polymers to the die. As is conventional, the polymeric materials may be supplied to the extruders 14a, b in the solid-state, e.g., in the form of pellets or flakes, via respective hoppers 16a, b. Extruders 14a, b are maintained at a temperature sufficient to convert the solid-state polymer to a molten state, and internal screws within the extruders (not shown) move the molten polymer into and through die 12 via respective pipes 18a, b. As will be explained in further detail below, within die 12, the molten polymer is converted into thin film layers, and each of the layers are superimposed, combined together, and expelled from the die at discharge end 20, i.e., “coextruded,” to form a tubular, multilayer film 22. Upon emergence from the die 12 at discharge end 20, the tubular, multilayer film 22 is exposed to ambient air or a similar environment having a temperature sufficiently low to cause the molten polymer from which the film is formed to transition from a liquid state to a solid state. Additional cooling/quenching of the film may be achieved by providing a liquid quench bath (not shown), and then directing the film through such bath.

The solidified tubular film 22 is then collapsed by a convergence device 24, e.g., a V-shaped guide as shown, which may contain an array of rollers to facilitate the passage of film 22 therethrough. A pair of counter-rotating drive rollers 25a, b may be employed as shown to pull the film 22 through the convergence device 24. The resultant collapsed tubular film 22 may then be wound into a roll 26 by a film winding device 28 as shown. The film 22 on roll 26 may subsequently be unwound for use, e.g., for packaging, or for further processing, e.g., stretch-orientation, irradiation, or other conventional film-processing techniques, which are used to impart desired properties as necessary for the intended end-use applications for the film.

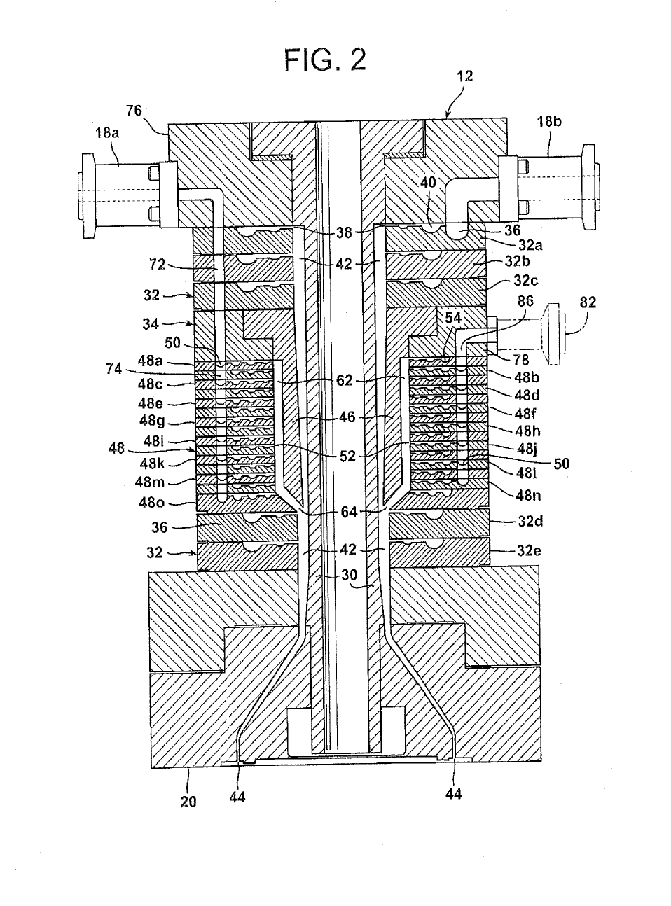

Referring now to FIG. 2, die 12 will be described in further detail. As noted above, die 12 is adapted to coextrude a plurality of fluid layers, and generally includes a primary forming stem 30, one or more distribution plates 32, and a microlayer assembly 34. In the presently illustrated die, five distribution plates 32 are included, as individually indicated by the reference numerals 32a-e. A greater or lesser number of distribution plates 32 may be included as desired. The number of distribution plates in die 12 may range, e.g., from one to twenty, or even more then twenty if desired.

Each of the distribution plates 32 has a fluid inlet 36 and a fluid outlet 38 (the fluid inlet is only shown in plate 32a). The fluid outlet 38 from each of the distribution plates 32 is in fluid communication with the primary forming stem 30, and also is structured to deposit a layer of fluid onto the primary forming stem. The distribution plates 32 may be constructed as described in U.S. Pat. No. 5,076,776, the entire disclosure of which is hereby incorporated herein by reference thereto. As described in the '776 patent, the distribution plates 32 may have one or more spiral-shaped fluid-flow channels 40 to direct fluid from the fluid inlet 36 and onto the primary forming stem 30 via the fluid outlet 38. As the fluid proceeds along the channel 40, the channel becomes progressively shallower such that the fluid is forced to assume a progressively thinner profile. The fluid outlet 38 generally provides a relatively narrow fluid-flow passage such that the fluid flowing out of the plate has a final desired thickness corresponding to the thickness of the fluid outlet 38. Other channel configurations may also be employed, e.g., a toroid-shaped channel; an asymmetrical toroid, e.g., as disclosed in U.S. Pat. No. 4,832,589; a heart-shaped channel; a helical-shaped channel, e.g., on a conical-shaped plate as disclosed in U.S. Pat. No. 6,409,953, etc. The channel(s) may have a semi-circular or semi-oval cross-section as shown, or may have a fuller shape, such as an oval or circular cross-sectional shape.

Distribution plates 32 may have a generally annular shape such that the fluid outlet 38 forms a generally ring-like structure, which forces fluid flowing through the plate to assume a ring-like form. Such ring-like structure of fluid outlet 38, in combination with its proximity to the primary forming stem 30, causes the fluid flowing through the plate 32 to assume a cylindrical shape as the fluid is deposited onto the stem 30. Each flow of fluid from each of the distribution plates 32 thus forms a distinct cylindrical “bulk” layer on the primary forming stem 30, i.e. layers that have greater bulk, e.g., thickness, than those formed from the microlayer assembly 34 (as described below).

The fluid outlets 38 of the distribution plates 32 are spaced from the primary forming stem 30 to form an annular passage 42. The extent of such spacing is sufficient to accommodate the volume of the concentric fluid layers flowing along the forming stem 30.

The order in which the distribution plates 32 are arranged in die 12 determines the order in which the fluidized bulk layers are deposited onto the primary forming stem 30. For example, if all five distribution plates 32a-e are supplied with fluid, fluid from plate 32a will be the first to be deposited onto primary forming stem 30 such that such fluid will be in direct contact with the stem 30. The next bulk layer to be deposited onto the forming stem would be from distribution plate 32b. This layer will be deposited onto the fluid layer from plate 32a. Next, fluid from plate 32c will be deposited on top of the bulk layer from plate 32b. If microlayer assembly 34 were not present in the die, the next bulk layer to be deposited would be from distribution plate 32d, which would be layered on top of the bulk layer from plate 32c. Finally, the last and, therefore, outermost bulk layer to be deposited would be from plate 32e. In this example (again, ignoring the microlayer assembly 34), the resultant tubular film 22 that would emerge from the die would have five distinct bulk layers, which would be arranged as five concentric cylinders bonded together.

Accordingly, it may be appreciated that the fluid layers from the distribution plates 32 are deposited onto the primary forming stem 30 either directly (first layer to be deposited, e.g., from distribution plate 32a) or indirectly (second and subsequent layers, e.g., from plates 32b-e).

As noted above, the tubular, multilayer film 22 emerges from die 12 at discharge end 20. The discharge end 20 may thus include an annular discharge opening 44 to allow the passage of the tubular film 22 out of the die. The die structure at discharge end 20 that forms such annular opening is commonly referred to as a “die lip.” As illustrated, the diameter of the annular discharge opening 44 may be greater than that of the annular passage 42, e.g., to increase the diameter of the tubular film 22 to a desired extent. This has the effect of decreasing the thickness of each of the concentric layers that make up the tubular film 22, i.e., relative to the thickness of such layers during their residence time within the annular passage 42. Alternatively, the diameter of the annular discharge opening 44 may be smaller than that of the annular passage 42.

Microlayer assembly 34 generally comprises a microlayer forming stem 46 and a plurality of microlayer distribution plates 48. In the presently illustrated embodiment, fifteen microlayer distribution plates 48a-o are shown. A greater or lesser number of microlayer distribution plates 48 may be included as desired. The number of microlayer distribution plates 48 in microlayer assembly 34 may range, e.g., from one to fifty, or more then fifty if desired. In many embodiments of the present invention, the number of microlayer distribution plates 48 in microlayer assembly 34 will be at least about 5, e.g., 10, 15, 20, 25, 30, 35, 40, 45, 50, etc., or any number of plates in between the foregoing numbers.

Each of the microlayer plates 48 has a fluid inlet 50 and a fluid outlet 52. The fluid outlet 52 from each of the microlayer plates 48 is in fluid communication with microlayer forming stem 46, and is structured to deposit a microlayer of fluid onto the microlayer forming stem. Similar to the distribution plates 32, the microlayer plates 48 may also be constructed as described in the above-incorporated U.S. Pat. No. 5,076,776.

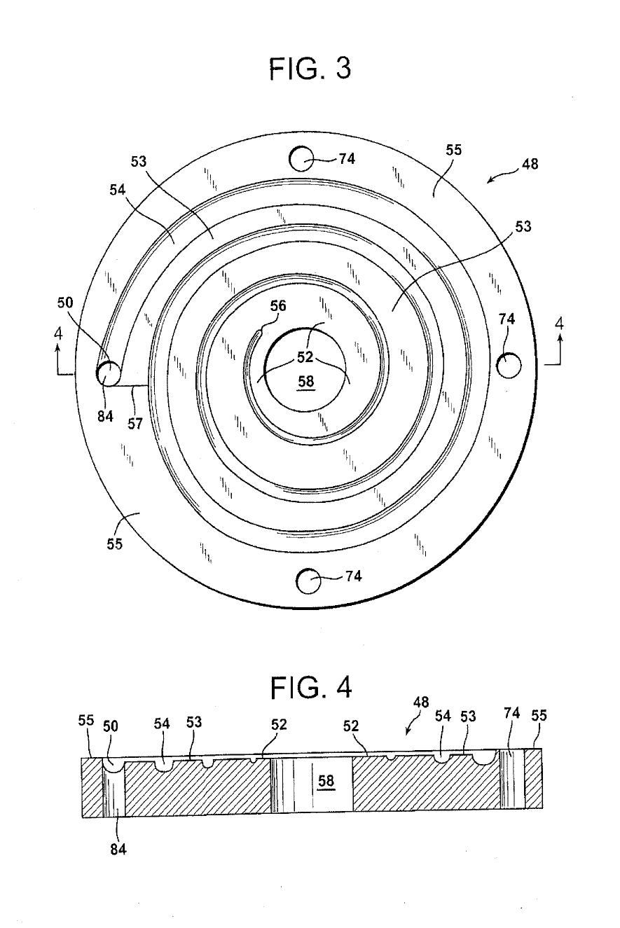

For example, as shown in FIG. 3, the microlayer plates 48 may have a spiral-shaped fluid-flow channel 54, which is supplied with fluid via fluid inlet 50. Alternatively, two or more fluid-flow channels may be employed in plate 48, which may be fed from separate fluid inlets or a single fluid inlet. Other channel configurations may also be employed, e.g., a toroid-shaped channel; an asymmetrical toroid, e.g., as disclosed in U.S. Pat. No. 4,832,589; a heart-shaped channel; a helical-shaped channel, e.g., on a conical-shaped plate as disclosed in U.S. Pat. No. 6,409,953; etc. The channel(s) may have a semi-circular or semi-oval cross-section as shown, or may have a fuller shape, such as an oval or circular cross-sectional shape.

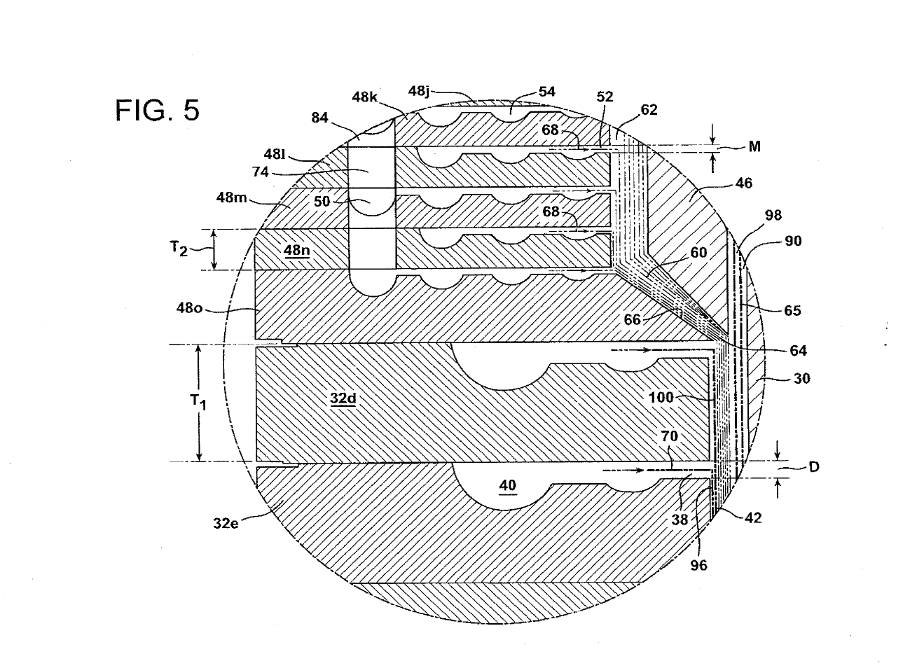

Regardless of the particular configuration or pattern that is selected for the flow channel(s) 54, its function is to connect the fluid inlet(s) 50 with the fluid outlet 52 in such a manner that the flow of fluid through the microlayer assembly 34 is converted from a generally stream-like, axial flow to a generally film-like, convergent radial flow towards the microlayer forming stem 46. Microlayer plate 48 as shown in FIG. 3 may accomplish this in two ways. First, the channel 54 spirals inwards towards the center of the plate, and thus directs fluid from the fluid inlet 50, located near the periphery of the plate, towards the fluid outlet 52, which is located near the center of the plate. Secondly, the channel 54 may be fashioned with a progressively shallower depth as the channel approaches the fluid outlet 52. This has the effect of causing some of the fluid flowing through the channel 54 to overflow the channel and proceed radially-inward toward the fluid outlet 52 in a relatively flat, film-like flow. Such radial-inward flow may occur in overflow regions 53, which may be located between the spaced-apart spiral sections of channel 54. As shown in FIG. 4, the overflow regions 53 may be formed as recessed sections in plate 48, i.e., recessed relative to the thicker, non-recessed region 55 at the periphery of the plate. As shown in FIG. 3, overflow regions 53 may begin at step-down 57 and, e.g., spiral inwards towards fluid outlet 52 between the spirals of channel 54. The non-recessed, peripheral region 55 abuts against the plate or other structure above the plate, e.g., as shown in FIGS. 2 and 5, and thus prevents fluid from flowing outside the periphery of the plate. In this manner, the non-recessed, peripheral region 55 forces fluid entering the plate to flow radially inward toward fluid outlet 52. Step-down 57 thus represents a line or zone of demarcation between the ‘no-flow’ peripheral region 55 and the ‘flow’ regions 53 and 54. The fluid that remains in the channel 54 and reaches the end 56 of the channel flows directly into the fluid outlet 52.

The fluid outlet 52 generally provides a relatively narrow fluid-flow passage and generally determines the thickness of the microlayer flowing out of the microlayer plate 48. The thickness of the fluid outlet 52, and therefore the thickness of the microlayer flowing therethrough, may be determined, e.g., by the spacing between the plate surface at outlet 52 and the bottom of the plate or other structure (e.g., manifold 76 or 78) immediately above the plate surface at outlet 52.

With continuing reference to FIGS. 2-3, each of the microlayer distribution plates 48 may have an orifice 58 extending through the plate. The orifice 58 may be located substantially in the center of each microlayer plate 48, with the fluid outlet 52 of each plate positioned adjacent to such orifice 58. In this manner, the microlayer forming stem 46 may extend through the orifice 58 of each of the microlayer distribution plates 48. With such a configuration, the microlayer distribution plates 48 may have a generally annular shape such that the fluid outlet 52 forms a generally ring-like structure, which forces fluid flowing through the plate to exit the plate in a radially-convergent, ring-like flow pattern. Such ring-like structure of fluid outlet 52, in combination with its proximity to the microlayer forming stem 46, causes the fluid exiting the microlayer plates 48 to assume a cylindrical shape as the fluid is deposited onto the microlayer stem 46. Each flow of fluid from each of the microlayer distribution plates 48 thus deposits a distinct cylindrical microlayer on the microlayer forming stem 46.

The microlayer plates 48 may be arranged to provide a predetermined order in which the microlayers are deposited onto the microlayer forming stem 46. For example, if all fifteen microlayer distribution plates 48a-o are supplied with fluid, a microlayer of fluid from plate 48a will be the first to be deposited onto microlayer forming stem 46 such that such microlayer will be in direct contact with the stem 46. The next microlayer to be deposited onto the forming stem would be from microlayer plate 48b. This microlayer will be deposited onto the microlayer from plate 48a. Next, fluid from microlayer plate 48c will be deposited on top of the microlayer from plate 48b, etc. The last and, therefore, outermost microlayer to be deposited is from plate 48o. In this manner, the microlayers are deposited onto the microlayer forming stem 46 in the form of a substantially unified, microlayered fluid mass 60 (see FIG. 5). In the present example, such microlayered fluid mass 60 would comprise up to fifteen distinct microlayers (at the downstream end of stem 46), arranged as fifteen concentric cylindrical microlayers bonded and flowing together in a predetermined order (based on the ordering of the microlayer plates 48a-o) on microlayer forming stem 46.

It may thus be appreciated that the fluid layers from the microlayer distribution plates 48 are deposited onto the microlayer forming stem 46 either directly (the first layer to be deposited, e.g., from microlayer plate 48a) or indirectly (the second and subsequent layers, e.g., from microlayer plates 48b-o). The orifices 58 in each of the microlayer plates 48 are large enough in diameter to space the fluid outlets 52 of the microlayer plates 48 sufficiently from the microlayer forming stem 46 to form an annular passage 62 for the microlayers (FIG. 2). The extent of such spacing is preferably sufficient to accommodate the volume of the concentric microlayers flowing along the microlayer stem 46.

In accordance with the present invention, microlayer forming stem 46 is in fluid communication with primary forming stem 30 such that the microlayered fluid mass 60 flows from the microlayer forming stem 46 and onto the primary forming stem 30. This may be seen in FIG. 5, wherein microlayered fluid mass 60 from microlayer assembly 34 is shown flowing from microlayer forming stem 46 and onto primary forming stem 30. Fluid communication between the microlayer stem 46 and primary stem 30 may be achieved by including in die 12 an annular transfer gap 64 between the annular passage 62 for the microlayer stem 46 and the annular passage 42 for the primary stem 30 (see also FIG. 2). Such transfer gap 64 allows the microlayered fluid mass 60 to flow out of the annular passage 62 and into the annular passage 42 for the primary forming stem 30. In this manner, the microlayers from microlayer plates 48 are introduced as a unified mass into the generally larger volumetric flow of the thicker fluid layers from the distribution plates 32.

The microlayer forming stem 46 allows the microlayers from the microlayer plates 48 to assemble into the microlayered fluid mass 60 in relative calm, i.e., without being subjected to the more powerful sheer forces of the thicker bulk layers flowing from the distribution plates 32. As the microlayers assemble into the unified fluid mass 60 on stem 46, the interfacial flow instabilities created by the merger of each layer onto the fluid mass 60 are minimized because all the microlayers have a similar degree of thickness, i.e., relative to the larger degree of thickness of the bulk fluid layers from distribution plates 32. When fully assembled, the microlayered fluid mass 60 enters the flow of the thicker bulk layers from distribution plates 32 on primary stem 30 with a mass flow rate that more closely approximates that of such thicker layers, thereby increasing the ability of the microlayers in fluid mass 60 to retain their physical integrity and independent physical properties.

As shown in FIG. 2, primary forming stem 30 and microlayer forming stem 46 may be substantially coaxially aligned with one another in die 12, e.g., with the microlayer forming stem 46 being external to the primary forming stem 30. This construction provides a relatively compact configuration for die 12, which can be highly advantageous in view of the stringent space constraints that exist in the operating environment of many commercial coextrusion systems.

Such construction also allows die 12 to be set up in a variety of different configurations to produce a coextruded film having a desired combination of bulk layers and microlayers. For example, one or more distribution plates 32 may be located upstream of the microlayer assembly 34. In this embodiment, fluidized bulk layers from such upstream distribution plates are deposited onto primary forming stem 30 prior to the deposition of the microlayered fluid mass 60 onto the primary stem 30. With reference to FIG. 2, it may be seen that distribution plates 32a-c are located upstream of microlayer assembly 34 in die 12. Bulk fluid layers 65 from such upstream distribution plates 32a-c are thus interposed between the microlayered fluid mass 60 and the primary forming stem 30 (see FIG. 5).

Alternatively, the microlayer assembly 34 may be located upstream of the distribution plates 32, i.e., the distribution plates may be located downstream of the microlayer assembly 34 in this alternative embodiment. Thus, the microlayers from the microlayer assembly 34, i.e., the microlayered fluid mass 60, will be deposited onto primary forming stem 30 prior to the deposition thereon of the bulk fluid layers from the downstream distribution plates 32. With reference to FIG. 2, it may be seen that microlayer assembly 34 is located upstream of distribution plates 32d-e in die 12. As shown in FIG. 5, the microlayered fluid mass 60 is thus interposed between the bulk fluid layer(s) 70 from such distribution plates 32d-e and the primary forming stem 30.

As illustrated in FIG. 2, the microlayer assembly 34 may also be positioned between one or more upstream distribution plates, e.g., plates 32a-c, and one or more downstream distribution plates, e.g., plates 32d-e. In this embodiment, fluid(s) from upstream plates 32a-c are deposited first onto primary stem 30, followed by the microlayered fluid mass 60 from the microlayer assembly 34, and then further followed by fluid(s) from downstream plates 32d-e. In the resultant multilayered film, the microlayers from microlayer assembly 34 are sandwiched between thicker, bulk layers from both the upstream plates 32a-c and the downstream plates 32d-e.

In many embodiments of the invention, most or all of the microlayer plates 48 have a thickness that is less than that of the distribution plates 32. Thus, for example, the distribution plates 32 may have a thickness T₁ (see FIG. 5) ranging from about 0.5 to about 2 inches. The microlayer distribution plates 48 may have a thickness T₂ ranging from about 0.1 to about 0.5 inch. Such thickness ranges are not intended to be limiting in any way, but only to illustrate typical examples. All distribution plates 32 will not necessarily have the same thickness, nor will all of the microlayer plates 48. For example, microlayer plate 48o, the most downstream of the microlayer plates in the assembly 34, may be thicker than the other microlayer plates to accommodate a sloped contact surface 66, which may be employed to facilitate the transfer of microlayered fluid mass 60 through the annular gap 64 and onto the primary forming stem 30.

As also shown in FIG. 5, each of the microlayers flowing out of the plates 48 has a thickness “M” corresponding to the thickness of the fluid outlet 52 from which each microlayer emerges. The microlayers flowing from the microlayer plates 48 are schematically represented in FIG. 5 by the phantom arrows 68.

Similarly, each of the relatively thick bulk layers flowing out of the plates 32 has a thickness “D” corresponding to the thickness of the fluid outlet 38 from which each such layer emerges (see FIG. 5). The thicker/bulk layers flowing from the distribution plates 32 are schematically represented in FIG. 5 by the phantom arrows 70.

Generally, the thickness M of the microlayers will be less than the thickness D of the bulk layers from the distribution plates 32. The thinner that such microlayers are relative to the bulk layers from the distribution plates 32, the more of such microlayers that can be included in a multilayer film, for a given overall film thickness. Microlayer thickness M from each microlayer plate 48 will generally range from about 0.5-25 mils (1 mil=0.001 inch). Thickness D from each distribution plate 32 will generally range from about 20-100 mils.

The ratio of M:D may range from about 1:1 to about 1:8. Thickness M may be the same or different among the microlayers 68 flowing from microlayer plates 48 to achieve a desired distribution of layer thicknesses in the microlayer section of the resultant film. Similarly, thickness D may be the same or different among the thicker bulk layers 70 flowing from the distribution plates 32 to achieve a desired distribution of layer thicknesses in the bulk-layer section(s) of the resultant film.

The layer thicknesses M and D will typically change as the fluid flows downstream through the die, e.g., if the melt tube is expanded at annular discharge opening 44 as shown in FIG. 2, and/or upon further downstream processing of the tubular film, e.g., by stretching, orienting, or otherwise expanding the tube to achieve a final desired film thickness and/or to impart desired properties into the film. The flow rate of fluids through the plates will also have an effect on the final downstream thicknesses of the corresponding film layers.

As described above, the distribution plates 32 and microlayer plates 48 preferably have an annular configuration, such that primary forming stem 30 and microlayer stem 46 pass through the center of the plates to receive fluid that is directed into the plates. The fluid may be supplied from extruders, such as extruders 14a, b. The fluid may be directed into the die 12 via vertical supply passages 72, which receive fluid from feed pipes 18, and direct such fluid into the die plates 32 and 48. For this purpose, the plates may have one or more through-holes 74, e.g., near the periphery of the plate as shown in FIG. 3, which may be aligned to provide the vertical passages 72 through which fluid may be directed to one or more downstream plates.

Although three through-holes 74 are shown in FIG. 3, a greater or lesser number may be employed as necessary, e.g., depending upon the number of extruders that are employed. In general, one supply passage 72 may be used for each extruder 14 that supplies fluid to die 12. The extruders 14 may be arrayed around the circumference of the die, e.g., like the spokes of a wheel feeding into a hub, wherein the die is located at the hub position.

With reference to FIG. 1, die 12 may include a primary manifold 76 to receive the flow of fluid from the extruders 14 via feed pipes 18, and then direct such fluid into a designated vertical supply passage 72, in order to deliver the fluid to the intended distribution plate(s) 32 and/or microlayer plate(s) 48. The microlayer assembly 34 may optionally include a microlayer manifold 78 to receive fluid directly from one or more additional extruders 80 via feed pipe 82 (shown in phantom in FIG. 1).

In the example illustrated in FIGS. 1-2, extruder 14b delivers a fluid, e.g., a first molten polymer, directly to the fluid inlet 36 of distribution plate 32a via pipe 18b and primary manifold 76. In the presently illustrated embodiment, distribution plate 32a receives all of the output from extruder 14b, i.e., such that the remaining plates and microlayer plates in the die 12 are supplied, if at all, from other extruders. Alternatively, the fluid inlet 36 of distribution plate 32a may be configured to contain an outlet port to allow a portion of the supplied fluid to pass through to one or more additional plates, e.g., distribution plates 32 and/or microlayer plates 48, positioned downstream of distribution plate 32a.

For example, as shown in FIGS. 3-4 with respect to the illustrated microlayer plate 48, an outlet port 84 may be formed in the base of the fluid inlet 50 of the plate. Such outlet port 84 allows the flow of fluid delivered to plate 48 to be split: some of the fluid flows into channel 54 while the remainder passes through the plate for delivery to one or more additional downstream plates 48 and/or 32. A similar outlet port can be included in the base of the fluid inlet 36 of a distribution plate 32. Delivery of fluid passing through the outlet port 84 (or through a similar outlet port in a distribution plate 32) may be effected via a through-hole 74 in an adjacent plate (see FIG. 5), or via other means, e.g., a lateral-flow supply plate, to direct the fluid in an axial, radial, and/or tangential direction through die 12 as necessary to reach its intended destination.

Distribution plates 32b-c are being supplied with fluid via extruder(s) and supply pipe(s) and/or through-holes that are not shown in FIG. 2. The bulk fluid flow along primary forming stem 30 from distribution plates 32a-c is shown in FIG. 5, as indicated by reference numeral 65.

As shown in FIGS. 1-2, microlayer assembly 34 is being supplied with fluid by extruders 14a and 80. Specifically, microlayer plates 48a, c, e, g, i, k, m, and o are supplied by extruder 14a via supply pipe 18a and vertical pipe and/or passage 72. Microlayer plates 48b, d, f, h, j, l, and n are supplied with fluid by extruder 80 via feed pipe 82 and a vertical supply passage 86. In the illustrated embodiment, vertical passage 86 originates in microlayer manifold 78 and delivers fluid only within the microlayer assembly 34. In contrast, vertical passage 72 originates in manifold 76, extends through distribution plates 32a-c (via aligned through-holes 74 in such plates), then further extends through manifold 78 via manifold passage 79 before finally arriving at microlayer plate 48a.

Fluid from extruder 14a and vertical passage 72 enters microlayer plate 48a at fluid inlet 50. Some of the fluid passes from inlet 50 and into channel 54 (for eventual deposition on microlayer stem 46 as the first microlayer to be deposited on stem 46), while the remainder of the fluid passes through plate 48a via outlet port 84. Microlayer plate 48b may be oriented, i.e., rotated, such that a through-hole 74 is positioned beneath the outlet port 84 of microlayer plate 48a so that the fluid flowing out of the outlet port 84 flows through the microlayer plate 48b, and not into the channel 54 thereof. Microlayer plate 48c may be positioned such that the fluid inlet 50 thereof is in the same location as that of microlayer plate 48a so that fluid flowing out of through-hole 74 of microlayer plate 48b flows into the inlet 50 of plate 48c. Some of this fluid flows into the channel 54 of plate 48c while some of the fluid passes through the plate via outlet port 84, passes through a through-hole 74 in the next plate 48d, and is received by fluid inlet 50 of the next microlayer plate 48e, where some of the fluid flows into channel 54 and some passes out of the plate via outlet port 84. Fluid from extruder 14a continues to be distributed to remaining plates 48g, i, k, and m in this manner, except for microlayer plate 48o, which has no outlet port 84 so that fluid does not pass through plate 48o, except via channel 54 and fluid outlet 52.

In a similar manner, fluid from extruder 80 and vertical passage 86 passes through microlayer plate 48a via a through-hole 74 and then enters microlayer plate 48b at fluid inlet 50 thereof. Some of this fluid flows through the channel 54 and exits the plate at outlet 52, to become the second microlayer to be deposited onto microlayer stem 46 (on top of the microlayer from plate 48a), while the remainder of the fluid passes through the plate via an outlet port 84. Such fluid passes through microlayer plate 48c via a through-hole 74, and is delivered to plate 48d via appropriate alignment of its inlet 50 with the through-hole 74 of plate 48c. This fluid-distribution process may continue for plates 48f, h, j, and l, until the fluid reaches plate 48n, which has no outlet port 84 such that fluid does not pass through this plate except via its fluid outlet 52.

In this manner, a series of microlayers comprising alternating fluids from extruders 14a and 80 may be formed on microlayer stem 46. For example, if extruder 14a supplied EVOH and extruder 80 supplied PA6, the resultant microlayered fluid mass 60 would have the structure:
EVOH/PA6/EVOH/PA6/EVOH/PA6/EVOH/PA6/EVOH/PA6/EVOH/PA6/EVOH/PA6/EVOH

The fluids from extruders 14a and 80 may be the same or different such that the resultant microlayers in microlayered fluid mass 60 may have the same or a different composition. Only one extruder may be employed to supply fluid to the entire microlayer assembly 34, in which case all of the resultant microlayers will have the same composition. Alternatively, three or more extruders may be used to supply fluid to the microlayer assembly 34, e.g., with each supplying a different fluid, e.g., polymer “a,” polymer “b,” and polymer “c,” respectively, such that three different microlayer compositions are formed in microlayered fluid mass 60, in any desired order, to achieve any desired layer-combination, e.g., abcabc; abbcabbc; abacabac; etc.

Similarly, the fluid(s) directed through the distribution plate(s) 32 may be substantially the same as the fluid(s) directed through the microlayer assembly 34. Alternatively, the fluid(s) directed through the distribution plate(s) 32 may be different from the fluid(s) directed through the microlayer assembly. The resultant tubular film may have bulk layers and microlayers that have substantially the same composition. Alternatively, some of the bulk layers from distribution plates 32 may be the same as some or all of the microlayers from microlayer plates 48, while other bulk layers may be different from some or all of the microlayers.

In the illustrated example, the extruders and supply passages for distribution plates 32d-e are not shown. One or both of such plates may be supplied from extruder 14a, 14b, and/or 80 by appropriate arrangement of vertical supply passages 72, 86, through-holes 74, and/or outlet ports 84 of the upstream distribution plates 32 and/or microlayer plates 48. Alternatively, one or both distribution plates 32d-e may not be supplied at all, or may be supplied from a separate extruder, such as an extruder in fluid communication with primary manifold 76 and a vertical supply passage 72 that extends through distribution plates 32a-c and microlayer assembly 34, e.g., via appropriate alignment of the through-holes 74 of plates 32a-c and microlayer assembly 34 to create a fluid transport passage through die 12, leading to fluid inlet 50 of distribution plate 32d and/or 32e.

If desired, one or more of the distribution plates 32 and/or microlayer plates 48 may be supplied with fluid directly from one or more extruders, i.e., by directing fluid directly into the fluid inlet of the plate, e.g., from the side of the plate, without the fluid being first routed through one of manifolds 76 or 78 and/or without using a vertical supply passage 72, 86. Such direct feed of one or more plates 32 and/or 48 may be employed as an alternative or in addition to the use of manifolds and vertical supply passages as shown in FIG. 2.

The inventors have discovered that the system 10 is particularly advantageous when used to make a multilayer, heat-shrinkable film, i.e., films that have been stretch-oriented such that they shrink upon exposure to heat, having an anti-fog material in either the microlayer section and/or in the bulk layer(s). The plurality of microlayers in the film results from the microlayered fluid mass 60 as described above, which forms a microlayer section 60 in the film.

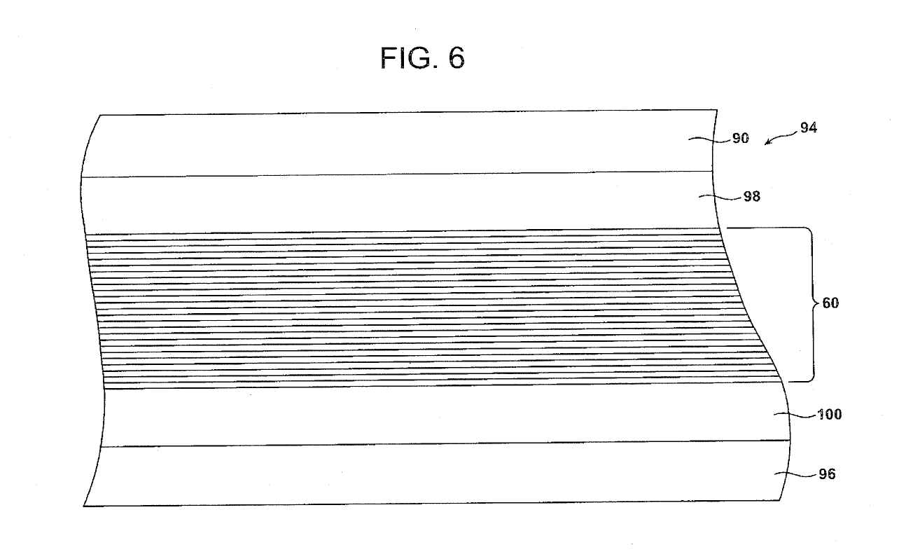

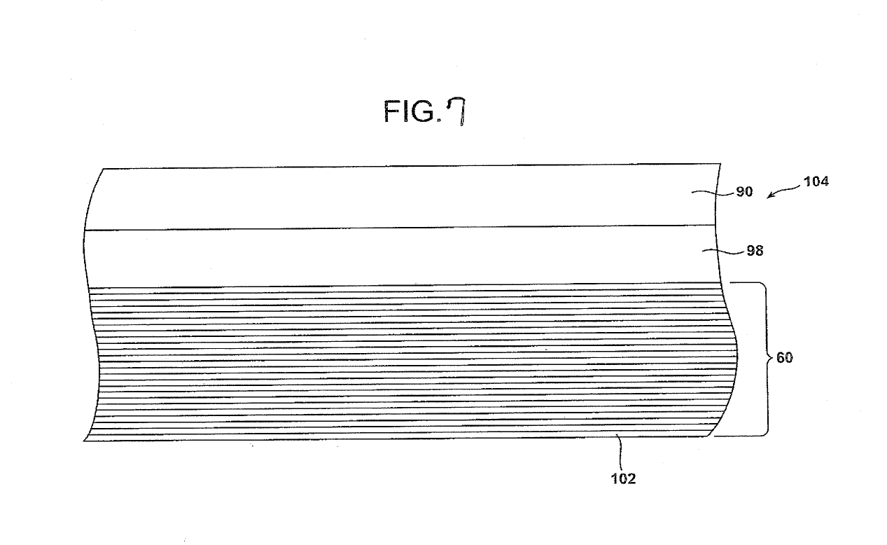

For example, heat-shrinkable films 94 in accordance with the present invention have at least one microlayer section 60, and one or more bulk layers, e.g., 90, 96, 98, and/or 100 (see, FIGS. 6 and 8), and preferably have a total free shrink (ASTM D2732-03) of at least about 10% at 200° F. Such films may be formed from system 10 by directing a first polymer 88 through extruder 14b and distribution plate 32a of die 12, and onto primary forming stem 30 such that the first polymer 88 is deposited onto primary forming stem 30 as a first bulk layer 90 (see FIGS. 1, 2 and 5). At least a second polymer 92 may be directed through extruder 14a and microlayer assembly 34, e.g., via vertical passage 72, to form microlayered fluid mass 60 on microlayer forming stem 46. The microlayered fluid mass 60 is then directed from microlayer forming stem 46 and onto primary forming stem 30. In this manner, the microlayered fluid mass 60 is merged with first bulk layer 90 within die 12 (FIG. 5), thereby forming multilayer film 22 (FIG. 1) as a relatively thick “tape” extrudate, which comprises the bulk layer 90 and microlayer section 60 as solidified film layers resulting from the fluid (molten) polymer layer 90 and microlayered fluid mass 60 within die 12.

As the coextruded, tubular multilayer “tape” 22 emerges from the discharge end 20 of die 12, it is quenched (e.g., via immersion in water) and then stretch-oriented under conditions that impart heat-shrinkability to the film. Such conditions, as described above in the Background section, may include reheating the multilayer “tape” to a temperature within its orientation temperature range, and then stretching the tape, e.g., as a blown bubble, to orient (align) the crystallites and/or molecules of the material, followed by quenching the film while substantially retaining its stretched dimensions to rapidly cool the film and thus lock-in the oriented molecular configuration. In this manner, the “tape” 22 is converted into a heat-shrinkable film 94, a cross-sectional view of which is shown in FIG. 6.

As may be appreciated, due to the stretching of the multilayer film or “tape” 22, the thickness of heat-shrinkable film 94 is significantly less than that of the tape 22. For example, while the tape 22 may have a thickness ranging from about 5 to about 50 mils, in many embodiments of the invention, the heat-shrinkable film 94 will have a thickness of less than 5 mils, such as 4 mils or less, 3 mils or less, 2 mils or less, etc. In some embodiments, the stretch-oriented shrink film 94 may be relatively very thin, i.e., less than 1 mil, e.g., less than about 0.9 mil, such as less than about 0.8 mil, less than about 0.7 mil, or less than about 0.6 mil, such as about 0.59 mil or less, 0.58 mil or less, 0.57 mil or less, 0.56 mil or less, 0.55 mil or less, 0.54 mil or less, 0.53 mil or less, etc. Advantageously, microlayers 60 in accordance with the present invention allow shrink film 94 to have an even lower thickness of 0.5 mil or less, such as less than 0.45 mil, or less than 0.40 mil, such as less than 0.39 mil, less than 0.38 mil, less than 0.37 mil, less than 0.36 mil, less than 0.35 mil, less than 0.34 mil, less than 0.33 mil, less than 0.32 mil, or less than 0.31 mil, such about 0.30 mil.

As shown in FIG. 5, first bulk layer 90 may be deposited onto primary forming stem 30 prior to the deposition of the microlayered fluid mass 60 onto the primary forming stem 30 such that the first layer 90 is interposed between the microlayered fluid mass 60 and the primary forming stem 30. If desired, a third polymer may be directed through a second distribution plate, e.g., distribution plate 32e (see FIG. 2; source of third polymer not shown). As shown in FIG. 5, the relatively thick flow 70 of such third polymer from distribution plate 32e may be merged with the microlayered fluid mass 60 to form a second bulk layer 96 for the multilayer film 94. In this manner, the microlayer section 60 may form a core for the multilayer film 94, with the first bulk layer 90 forming a first outer layer for the multilayer film 94 and the second bulk layer 96 forming a second outer layer therefor. Thus, in the embodiment illustrated in FIG. 6, heat-shrinkable film 94 comprises microlayer section 60 positioned between the first and second bulk, outer layers 90, 96.

The second polymer 92 may be substantially the same as the first polymer 88, such that the composition of the first bulk layer 90 may be substantially the same as that of the microlayers in microlayer section 60. Alternatively, the second polymer 92 may be different from the first polymer 88, such that the composition of the first layer 90 may be different from that of the microlayers. Similarly, the composition of second bulk layer 96 may be the same or different from that of first layer 90, and also the same or different from that of the microlayers in section 60.

As a further variation, a first intermediate bulk layer 98 may be interposed between the first outer layer 90 and the microlayer section 60 in shrink film 94. Similarly, a second intermediate bulk layer 100 may be interposed between the second outer layer 96 and the microlayer section 60. The composition of layers 90 and 98 may be the same or different. Similarly, the composition of layers 96 and 100 may be the same or different. First intermediate bulk layer 98 may be formed from polymer directed through distribution plate 32b while second intermediate bulk layer 100 may be formed from polymer directed through distribution plate 32e (see FIGS. 2 and 5). If the composition of layers 90 and 98 is the same, the same extruder 14b may be used to supply both of distribution plates 32a and 32b. If the composition of such layers is different, two different extruders are used to supply the distribution plates 32a and 32b. The foregoing also applies to the supply of polymer to distribution plates 32d and 32e.

To make the shrink film illustrated in FIG. 6, no polymer was supplied to distribution plate 32c. If polymer was supplied to distribution plate 32c, the resultant shrink film would have an additional intermediate bulk layer between layer 98 and microlayer section 60.

Shrink film 94, as illustrated in FIG. 6, is representative of many of the inventive shrink films described in the Examples below, in that such films have a total of twenty five (25) microlayers in the core of the film. The die used to make such films was essentially as illustrated in FIG. 2, except that twenty five (25) microlayer plates were included in the microlayer assembly 34. For simplicity of illustration, only fifteen (15) microlayer plates are shown in the microlayer assembly 34 of die 12 in FIG. 2. Generally, the microlayer section 60 may comprise any desired number of microlayers, e.g., at least 10 microlayers, such as at least: 11 microlayers, 12, 13, 14, 15, 16, 17, 18, 19, 20 microlayers, etc., or more, e.g., at least 20 microlayers, at least: 25, 30, 35, 40, 45, or 50 microlayers, or more than 50 microlayers, e.g., numbering in the hundreds or even thousands, as desired. For instance, the number of microlayers may range, e.g., between 2 and 50 microlayers, between 3 and 40 microlayers, between 4 and 30 microlayers, etc.

Each of the microlayers in section 60 may have substantially the same composition. This would be the case, e.g., if all microlayer plates 48 were supplied with polymer by extruder 14a. Alternatively, at least one of the microlayers 60 may have a composition that is different from the composition of at least one other of the microlayers, i.e., two or more of the microlayers may have compositions that are different from one other. This can be accomplished, e.g., by employing extruder 80 to supply a different polymer (i.e., different from the polymer supplied by extruder 14a) to at least one of the microlayer plates 48. Thus, as shown in FIGS. 1 and 2, extruder 14a may supply the “odd” microlayer plates (i.e., plates 48a, c, e, etc.) with one type of polymeric composition, e.g., “composition A,” while extruder 80 supplies the “even” microlayer plates (i.e., plates 48b, d, f, etc.) with another type of polymeric composition, e.g., “composition B,” such that the microlayer section 60 will comprise alternating microlayers of “A” and “B”, i.e., ABABAB . . . . A third extruder supplying a polymeric composition “C” could also be employed, e.g., to provide a repeating “ABC” ordering of the microlayers, i.e., ABCABC . . . . Numerous other variations are, of course, possible.

Each of the microlayers 60 in heat-shrinkable film 94 may have substantially the same thickness. Alternatively, at least one of the microlayers may have a thickness that is different from the thickness of at least one other of the microlayers. The thickness of the microlayers 60 in shrink film 94 will be determined by a number of factors, including the construction of the microlayer plates, e.g., the spacing “M” of the fluid outlet 52 (FIG. 5), the mass flow rate of fluidized polymer that is directed through each plate, the degree of stretching to which the tape 22/shrink film 94 is subjected during orientation, etc.

In accordance with the present invention, each of the microlayers 60 in shrink film 94 have a thickness that is significantly less than that of the bulk layers in the film, i.e., those produced by the relatively thick distribution plates 32. “Microlayers” are thin, generally very thin, in relation to conventional or “bulk” layers, with films in accordance with the invention advantageously including a combination of both types of layers. This relationship may be expressed mathematically, e.g., as a ratio, given that each of the microlayers and bulk layers have a thickness. Thus, for example, the ratio of the thickness of any of the microlayers 60 to the thickness of bulk layer 90 is at least about 1:2 (the foregoing phrase “at least” modifies the second number in the ratio), such as at least about 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, etc., for example ranging from 1:2-1:50, 1:3-1:40, 1:4-1:35, 1:5-1:30, etc. The same thickness ratio range may apply to each of the microlayers 60 relative any of the other bulk layers in shrink film 94, e.g., second outer layer 96 or intermediate layers 98 and/or 100.

Each of the microlayers 60 may have a thickness as low as about 0.001 mil, e.g., ranging from 0.001 to 0.1 mil, such as from 0.005 to 0.08 mil, 0.01 to 0.05 mil, etc. The bulk layers may have a thickness as great as desired, e.g., up to about 5 mils, but generally ranging from about 0.01 to 2.5 mils, such as from 0.05 to 1.0 mil, 0.06 to 0.5 mil, etc.

During the stretch-orientation process to which the tape 22 is subjected to convert it into shrink film 94, the tape 22 may be oriented such that the film 94 has an orientation ratio, e.g., of at least 3, as measured in at least one direction along a length or width dimension of the film, e.g., the transverse direction (TD) or machine direction (MD). The inclusion of microlayers in a heat-shrinkable film was found to provide the film with the ability to be stretched at even higher orientation ratios, e.g., an orientation of at least 5, as measured in at least one direction along a length or width dimension of the film. For example, films in accordance with the present invention were able to be oriented at a “5×5” ratio, i.e., the tape was stretched to five times its original width and five times its original length during the stretch-orientation process, such that the resultant film was not only rendered heat-shrinkable, but was twenty five (25) times its original size (surface area), when it was as an extruded tape emerging from die 12. Some films in accordance with the present invention could even be stretched at an orientation ratio of 6×6, i.e., the resultant shrink film was stretched to thirty six (36) times its original size as when it was an extruded tape. Such high orientation ratios are advantageous because they allow for a high degree of process efficiency in terms of through-put and polymer usage, which allows a greater amount of film to be produced from a given extrusion system.

In many applications, shrink films are used in conjunction with automated shrink-wrap packaging machines, in which the films are subjected to numerous folding and bending moves as the film is manipulated by the machine to envelop the object to be packaged, which initiate tears and place tear propagation stresses on the film. Shrink films having a relatively low Elemendorf Tear resistance (ASTM D 1922-06a) exhibit a relatively high rate of tearing in automated shrink packaging machines; conversely, those having a relatively high Elemendorf Tear resistance have a relatively low rate of machine tearing. In general, shrink films having an Elemendorf Tear value of at least 10 grams are capable of good performance with minimal tearing in almost all types and brands of shrink packaging equipment. Films in accordance with the present invention generally have an Elemendorf Tear value of at least 10 grams, or at least 30 grams/mil on a normalized basis, as measured in at least one direction along a length or width dimension of the film, even when such films have a thickness of less than about 0.7 mil, e.g., less than about 0.65 mil, such as less than about 0.6 mil, less than about 0.55 mil, less than about 0.5 mil, less than about 0.45 mil, less than about 0.4 mil, or less than about 0.35 mil.

If desired, all of the microlayers 60 may comprise a single polymer. Alternatively, at least one of the microlayers 60 may comprise a blend of two or more polymers, e.g., wherein the microlayers may alternate between two different polymeric compositions, i.e., with every other microlayer having a different composition. For example, at least one of the microlayers may comprise a blend of two more polymers and may have a composition that is different from at least one other microlayer. Thus, for example, microlayer section 60 may comprise a repeating sequence of layers represented by the structure:
A/B,
   wherein,

A represents a microlayer comprising one or more polymers,

B represents a microlayer comprising a blend of two or more polymers, and

A has a composition that is different from that of B.

The repeating sequence of the “A/B” layers may have no intervening layers, i.e., wherein the microlayer section 60 contains only layers “A” and “B” as described above (with layer “B” being a blend of two or more polymers). Alternatively, one or more intervening layers may be present between the “A” and “B” layers, e.g., a microlayer “C”, comprising a polymer or polymer blend that is different from those in the “A” and “B” microlayers, such that the repeating sequence of layers has the structure “A/B/C/NB/C . . . ”, “A/C/B/NC/B . . . ”, etc.

Other sequences are, of course, also possible, such as “A/A/B/A/A/B . . . ”, “A/B/B/NB/B . . . ”, etc., with the “A/B” (or A/B/C, A/A/B, A/B/B, etc.) sequence being repeated as many times as necessary to obtain a desired number of microlayers in microlayer section 60.

Microlayers A and/or B may comprise one or more of ethylene/alpha-olefin copolymer, ethylene/vinyl acetate copolymer, polypropylene homopolymers or copolymer, ethylene/methacrylic acid copolymer, maleic anhydride-grafted polyethylene, polyamide, and/or low density polyethylene. The foregoing polymers may be obtained from “virgin” resin and/or from recycled polymer, and may be employed in each layer individually or as blends of two or more of the resins.

More generally, in the production of heat-shrinkable films in accordance with the present invention, the fluid layers coextruded by die 12, including both the bulk layers and microlayers, may comprise one or more molten thermoplastic polymers. Examples of such polymers include polyolefins, polyesters (e.g., PET and PETG), polystyrenes, (e.g., modified styrenic polymers such as SEBS, SBS, etc.), polyamide homopolymers and copolymers (e.g. PA6, PA12, PA6/12, etc.), polycarbonates, etc. Within the family of polyolefins, various polyethylene homopolymers and copolymers may be used, as well as polypropylene homopolymers and copolymers (e.g., propylene/ethylene copolymer). Polyethylene homopolymers may include low density polyethylene (LDPE) and high density polyethylene (HDPE). Suitable polyethylene copolymers may include a wide variety of polymers, such as, e.g., ionomers, ethylene/vinyl acetate (EVA), ethylene/vinyl alcohol (EVOH), and ethylene/alpha-olefins, including heterogeneous (Zeigler-Natta catalyzed) and homogeneous (metallocene, single-cite catalyzed) ethylene/alpha-olefin copolymers. Ethylene/alpha-olefin copolymers are copolymers of ethylene with one or more comonomers selected from C₃ to C₂₀ alpha-olefins, such as 1-butene, 1-pentene, 1-hexene, 1-octene, methyl pentene and the like, including linear low density polyethylene (LLDPE), linear medium density polyethylene (MDPE), very low density polyethylene (VLDPE), and ultra-low density polyethylene (ULDPE).

At least one of the microlayers may comprise recycled polymer, which may be obtained from a variety of sources, including initial production of multilayer films prior to steady-state operation; out-of-spec (improperly formed) film; portions of film that are mechanically trimmed and separated from the main film web in order to achieve a predetermined web width; etc. The microlayer section 60 may comprise between 1 and 50 weight percent recycled polymer, based on the total weight of the film, even when the film has a thickness of less than 0.7 mil.

Multilayer, heat-shrinkable films in accordance with the present invention may have a total free shrink (ASTM D2732-03) of at least about 10% at 200° F., such as about 15% or greater, about 20% or greater, etc. Total free shrink is the sum of the free shrink in both the TD and LD, as tested per ASTM D2732-03.

FIG. 7 illustrates an alternative embodiment of the invention, in which the microlayer section 60 is positioned at an exterior surface of the film, such that one of the microlayers forms an outer layer 102 for the resultant heat-shrinkable, multilayer film 104. Thus, in contrast to shrink film 94, in which the microlayer section 60 is in the interior of the film, in shrink film 104, the microlayer section 60 is positioned at the outside of the film such that microlayer 102 forms an outer layer for the film. Film 104 may be formed from die 12 as described above in relation to film 94, except that no fluidized polymer would be directed through distribution plates 32d or 32e such that bulk layers 96 and 100 are omitted from the film structure. In the resultant tube 22 that emerges from die 12, bulk layer 90 would thus be the inner-most layer of the tube while microlayer 102 would form the outer-most layer. Such tube 22 is then stretch-oriented as described above, e.g., via the blown bubble or tenterframe process, to make shrink film 104.

As an alternative, shrink film 104 may be converted into a shrink film having a pair of microlayers 102 on both of the opposing outer layers of the film. To make such a film, die 12 may be configured as described immediately above, with the resultant tube 22 being stretch-oriented via the blown bubble process to make shrink film 104 in the form of a heat-shrinkable/expanded tube. Such expanded tube may then be collapsed and welded together such that the inner bulk layer 90 adheres to itself. The resultant shrink film has microlayer section 60 on both outer surfaces of the film, with a pair of bulk layers 90 in the center of the film, and a pair of intermediate bulk layers 98 spaced from one another by the pair of bulk layers 90. In this configuration, a pair of microlayers 102 forms both of the opposing outer layers for the film. Such film thus has microlayered “skins” with one or more bulk layers in the core. If desired, a material may be included at the inner-most layer of the tube to facilitate the welding of the tube to itself, e.g., a layer of EVA or an adhesive, e.g., anhydride-grafted polymer, which may be directed through plate 32a of die 12, with bulk layers 90 and 98 being formed from plates 32b and 32c, respectively.

If desired, a second microlayer assembly 34 may be added to die 12, which forms a second microlayer section in the resultant shrink film. Accordingly, another way to form a shrink film having a microlayer section at both outer surfaces of the film is to configure die 12 such the distribution plates 32 are sandwiched between both microlayer assemblies 34. Such configuration will produce a shrink film having microlayered skins with one or more bulk layers in the core, without the need to collapse and weld the inflated tube as described above.

An alternative configuration of die 12 will also result in shrink film 104 as shown in FIG. 7. In such configuration, the supply of fluidized polymer to die 12 may be arranged such that microlayered fluid mass 60 is deposited onto primary forming stem 30 prior to the deposition of bulk layer 90 onto the primary forming stem 30. In this manner, the microlayered fluid mass 60 is interposed between the bulk layer 90 and primary forming stem 30. In this case, with reference to FIG. 2, no fluidized polymer would be supplied to distribution plates 32a-c. Instead, the bulk layer 90 would be formed by supplying fluidized polymer to distribution plate 32e, and the intermediate bulk layer 98 would be formed by supplying fluidized polymer to distribution plate 32d. In the resultant tube 22 that emerges from die 12, bulk layer 90 would thus be the outer-most layer of the tube while microlayer 102 would form the inner-most layer. Such tube 22 is then stretch-oriented as described above, e.g., via the blown bubble or tenterframe process, to make shrink film 104.

The inventors hereof have discovered that heat-shrinkable films having sufficiently low shrink force to package easily-distortable products may be produced by combining a bulk layer and a microlayer section comprising at least about ten microlayers, wherein:

each of the microlayers and the bulk layer have a thickness, the thickness of any of the microlayers being at least half the thickness of the bulk layer;

the film has a film density of less than or equal to 0.940 g/cc; and

the microlayer section comprises a repeating sequence of layers represented by the structure:
A/B,
   wherein,

A represents a microlayer comprising cyclic olefin copolymer and/or a blend of two or more different polymers, at least one of which is polypropylene copolymer, and

B represents a microlayer comprising a polymer or polymer blend having a composition that is different from that of A.

The foregoing film may have a thickness of less than about 0.7 mil.

Either or both of the foregoing films may further include at least a second bulk layer, and the microlayer section may be positioned between the bulk layers.

The microlayers in the foregoing films may each have a thickness ranging from about 0.001 to 0.1 mil.

In any of the foregoing films, the ratio of the thickness of any of the microlayers to the thickness of the bulk layer may be at least about 1:3.

Any of the foregoing films may have a total free shrink (ASTM D2732-03) of at least about 10% at 200° F.

In any of the foregoing films, the propylene copolymer may comprise propylene/ethylene copolymer. In such case, the propylene/ethylene copolymer may comprise ethylene in an amount ranging from 1% to 25% by weight, such as
2% to 20% by weight, 3% to 15% by weight, etc.

Surprisingly, the foregoing films have been found to result in a sufficiently low shrink force that easily-distortable products, such as furnace filters, thin stacks of paper, etc. may be packaged with minimal or no distortion. Further reference in this regard may be made to the following Examples.

### EXAMPLES

The materials used in the examples are identified below:
1. COC-1 Topas 9903D; ethylene/norbornene copolymer with a glass transition temperature of 33° C. (ASTM D7426), giving a melt flow index of 1.0 g/10 min (ASTM D-1238), a density of 0.974 g/cc (ASTM D-1505); purchased from Topas Advanced Polymers, Inc.
2. EVA-1 EF437AA; an ethylene/vinyl acetate copolymer with 2.5% vinyl acetate content, giving a melt flow index of 2.0 g/10 min (ASTM D-1238), a density of 0.9250 g/cc (ASTM D-1505); purchased from Westlake Chemicals.
3. EVA-2 Escorene LD705.MJ; an ethylene/vinyl acetate copolymer with 2.8% vinyl acetate content, giving a melt flow index of 0.4 g/10 min (ASTM D-1238), a density of 0.935 g/cc (ASTM D-1505); purchased from Exxon Mobil.
4. EVA-3 EB502AA; an ethylene/vinyl acetate copolymer with 12.5% vinyl acetate content, giving a melt flow index of 0.5 g/10 min (ASTM D-1238), a density of 0.934 g/cc (ASTM D-1505); purchased from Westlake Chemical.
5. EPC-1 Versify 2200, a propylene/ethylene copolymer, giving a melt flow index of 2.0 g/10 min (ASTM D-1238) and a density of 0.876 g/cc (ASTM D-1505); purchased from Dow Chemicals.
6. EPC-2 Vistamaxx 3000, a propylene/ethylene copolymer, giving a melt flow index of 8.0 g/10 min (ASTM D-1238) and a density of 0.873 g/cc (ASTM D-1505); purchased from ExxonMobil.
7. EPC-3 Pro-fax SR257M, a propylene/ethylene copolymer, giving a melt flow index of 2.0 g/10 min (ASTM D-1238) and a density of 0.902 g/cc (ASTM D-1505); purchased from LyondellBasell.
8. EPC-4 Adsyl 7415 XCP, a propylene/ethylene copolymer, giving a melt flow index of 7 g/10 min (ASTM D-1238) and a density of 0.900 g/cc (ASTM D-1505); purchased from LyondellBasell.
9. EPC-5 8473, a propylene/ethylene copolymer, having a melt flow index of 4.6 g/10 min (ASTM D-1238) and a density of 0.895 g/cc (ASTM D-1505); purchased from Total Petrochemicals.
10. LLDPE-1 Dowlex 2045; a homogeneous ethylene/octene copolymer, having a melt flow index of 1.0 g/10 min (ASTM D-1238), a specific gravity of 0.920 g/cc (ASTM D-792), a Vicat softening point of 107.8° C. (ASTM D-1525) and a melting temperature of 122.2° C. (Dow's Internal Method); purchased from Dow Chemicals.
11. LLDPE-2 Enable 2010CB; a homogeneous ethylene/hexene copolymer, having a melt flow index of 1.0 g/10 min (ASTM D-1238), a specific gravity of 0.920 g/cc (ASTM D-792), and a melting temperature of 115° C.; purchased from ExxonMobil.
12. LLPDE-3 Exceed 1012HJ; a homogeneous ethylene/hexene copolymer, having a melt flow index of 1.0 g/10 min (ASTM D-1238), a specific gravity of 0.912 g/cc (ASTM D-792), and a melting temperature of 115° C., purchased from ExxonMobil.
13. MB-1 An internally compounded ethylene/vinyl acetate copolymer masterbatch containing 1.25% diatomaceous earth silica, 3.50% n, n′-ethylene bis-stearamide, 4.5% erucamide, and 3.3% anhydrous aluminum silicate with a density of 0.962 g/cc (ASTM D-1505).
14. MB-2 An internally compounded ethylene/vinyl acetate copolymer masterbatch with 1.8% n, n′-ethylene bis-stearamide, 3.0% erucamide, 0.9% oleamide, and 2.0% % anhydrous aluminum silicate with a density of 0.962 g/cc (ASTM D-1505).
15. MB-3 An internally compounded linear low density polyethylene masterbatch with 4.4% n, n′-ethylene bis-stearamide.
16. MB-4 An internally compounded medium density polyethylene masterbatch with 3.0% n, n′-ethylene bis-stearamide, 4.0% erucamide, and 3.0% anhydrous aluminum silicate.
17. MB-5 An internally compounded polypropylene homopolymer masterbatch with 0.54% calcium stearate, 0.8% behenamide, 2.0% n, n′-ethylene bis-stearamide, 2.4% erucamide, and 4.0% anhydrous aluminum silicate.
18. MDPE-1 Dowlex 2037 with a density of 0.935 g/cc, melt flow rate of 2.5 g/10 min, and a melting temperature of 124.7° C. produced by Dow Chemical.
19. OBC-1: Infuse EP D9007; an olefin block copolymer, having a melt flow index of 0.5 g/10 min (ASTM D-1238) and a specific gravity of 0.866 g/cc (ASTM D-792), and a melting temperature of 119° C. (Dow's Internal Method); purchased from Dow Chemicals.
20. OBC-2 Infuse 9100.05; an olefin block copolymer, having a melt flow index of 1.0 g/10 min (ASTM D-1238) and a specific gravity of 0.877 g/cc (ASTM D-792), and a melting temperature of 120° C. (Dow's Internal Method); purchased from Dow Chemicals.
21. VLDPE-1 Affinity PL 1880G; a branched ethylene/octene copolymer very low density polyethylene, produced by INSITE technology, with a melt index of 1.1 g/10 min (ASTM D-1238), a specific gravity of 0.902 g/cc (ASTM D-792), and a melting point of 99° C. (Dow's Internal Method): purchased from Dow Chemicals.
22. VLDPE-2 Engage 8150; a branched ethylene/octene copolymer very low density polyethylene, produced by INSITE technology, with a melt index of 0.5 g/10 min (ASTM D-1238), a specific gravity of 0.867 g/cc (ASTM D-792), and a melting point of 55° C. (Dow's Internal Method): purchased from Dow Chemicals.
23. VLDPE-3 Affinity PL 1800; a branched ethylene/octene copolymer very low density polyethylene, produced by INSITE technology, with a melt index of 1.0 g/10 min (ASTM D-1238), a specific gravity of 0.8675 g/cc (ASTM D-792), and a melting point of 99° C. (Dow's Internal Method): purchased from Dow Chemicals.
24. VLDPE-4 Affinity PL 1840; a branched ethylene/octene copolymer very low density polyethylene, produced by INSITE technology, with a melt index of 1.0 g/10 min (ASTM D-1238), a specific gravity of 0.909 g/cc (ASTM D-792), and a melting point of 106° C. (Dow's Internal Method): purchased from Dow Chemicals.
25. VLDPE-5 Exceed 1012CJ; a linear ethylene/hexene copolymer very low density polyethylene, produced by single site catalyst, with a melt index of 1.0 g/10 min (ASTM D-1238), a density of 0.912 g/cc (ASTM D-1505), and a melting point of 116° C.; purchased from ExxonMobil.
26. VLDPE-6 Affinity PL 1850G; a branched ethylene/octene copolymer very low density polyethylene, produced by INSITE technology, with a melt index of 3.0 g/10 min (ASTM D-1238), a specific gravity of 0.902 g/cc (ASTM D-792), and a melting point of 97° C. (Dow's Internal Method): purchased from Dow Chemicals.

### Example 1

A multilayer film was made by the process described below, and had the following twenty-nine layer structure with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 70% EPC-3+10% OBC-1+20% VLDPE-5 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

The film was fully coextruded through an annular microlayer die and then stretch-oriented by the blown bubble coextrusion process in accordance with the method described in U.S. Pat. No. 8,012,572, the entire disclosure of which is hereby incorporated herein by reference thereto. The film was first coextruded as tape using the die in a 29-layer configuration, followed by a water quench upon exiting the die. With reference to FIG. 2, the microlayer die assembly included a total of 25 microlayer distribution plates 48 and four distribution plates 32. Fluidized (molten) polymer was supplied to each of the microlayer distribution plates to form 25 microlayers, while four bulk layers were formed by supplying fluidized polymer to distribution plates 32a, b, d, and e (no polymer was supplied to plate 32c). The resultant 29-layer structure comprised a core with 25 microlayers (layers 3-27), plus 4 thicker layers (layers 1-2 and 28-29). Thick layers 1-2 were positioned on one side of the core and thick layers 28-29 were positioned on the other side of the core, with layer 1 forming one of the outer layers and layer 29 forming the other outer layer.

The tape was then subjected to electron beam irradiation to promote cross-linking, at a dosage of between 7 to 8 milli-amps (approximated values), and then preheated in an oven for orientation. The tape was then oriented as a bubble at an orientation ratio of approximately 5×5 in both the Longitudinal Direction (LD) and Transverse Direction (TD). An air ring was used to quench the oriented film. The bubble was then collapsed and wound into a film roll.

### Example 2

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 80% EPC-3+20% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 3

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 50% EPC-3+50% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 4

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 40% EPC-3+60% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 5

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 30% EPC-3+70% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 6

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 20% EPC-3+80% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 7

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 10% EPC-3+90% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 8

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 30% EPC-3+20% OBC-1+50% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 9

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 86% EPC-1+14% MB-2 (16.7% of total thickness of layers 1-29)
Layers 3, 5, 7, 9, 11, 13, 15, 17, 19, 21, 23, 25, 27: 100% EPC-1 (17.3% of total thickness of layers 1-29)
Layers 4, 6, 8, 10, 12, 14, 16, 18, 20, 22, 24, 26: 75% EVA-2+25% LLDPE-1 (17.3% of total thickness of layers 1-29)
Layer 28: 86% EPC-1+14% MB-2 (16.7% of total thickness of layers 1-29)
Layer 29: 83% LLDPE-1+17% MB-1 (16% of total thickness of layers 1-29)

### Example 10

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 86% EPC-1+14% MB-2 (16.7% of total thickness of layers 1-29)
Layers 3, 5, 7, 9, 11, 13, 15, 17, 19, 21, 23, 25, 27: 75% EPC-1+25% LLDPE-1 (17.3% of total thickness of layers 1-29)
Layers 4, 6, 8, 10, 12, 14, 16, 18, 20, 22, 24, 26: 75% EVA-2+25% LLDPE-1 (17.3% of total thickness of layers 1-29)
Layer 28: 86% EPC-1+14% MB-2 (16.7% of total thickness of layers 1-29)
Layer 29: 83% LLDPE-1+17% MB-1 (16% of total thickness of layers 1-29)

### Example 11

A multilayer film in accordance with the present invention was made and had the following twenty nine-layer structure, with a total film thickness of 0.35 mils:
Layer 1: 83% LLDPE-1+17% MB-1 (16% of total thickness of layers 1-29)
Layer 2: 61% EPC-1+14% MB-2+25% LLDPE-1 (16.7% of total thickness of layers 1-29)
Layers 3, 5, 7, 9, 11, 13, 15, 17, 19, 21, 23, 25, 27: 75% EPC-1+25% LLDPE-1 (17.3% of total thickness of layers 1-29)
Layers 4, 6, 8, 10, 12, 14, 16, 18, 20, 22, 24, 26: 75% EVA-2+25% LLDPE-1 (17.3% of total thickness of layers 1-29)
Layer 28: 61% EPC-1+14% MB-2+25% LLDPE-1 (16.7% of total thickness of layers 1-29)
Layer 29: 83% LLDPE-1+17% MB-1 (16% of total thickness of layers 1-29)

### Example 12

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 43% VLDPE-3+14% MB-2+43% LLDPE-1 (16.7% of total thickness of layers 1-29)
Layers 3, 5, 7, 9, 11, 13, 15, 17, 19, 21, 23, 25, 27: 75% EPC-1+25% LLDPE-1 (17.3% of total thickness of layers 1-29)
Layers 4, 6, 8, 10, 12, 14, 16, 18, 20, 22, 24, 26: 75% EVA-2+25% LLDPE-1 (17.3% of total thickness of layers 1-29)
Layer 28: 43% VLDPE-3+14% MB-2+43% LLDPE-1 (16.7% of total thickness of layers 1-29)
Layer 29: 83% LLDPE-1+17% MB-1 (16% of total thickness of layers 1-29)

### Example 13

A multilayer film was made by the process described above for Example 1, and had the following twenty-nine layer structure with a total film thickness of 0.35 mils:
Layer 1: 83% LLDPE-1+17% MB-1 (12% of total thickness of layers 1-29)
Layer 2: 15% MB-2+40% VLDPE-4+45% LLDPE-1 (18% of total thickness of layers 1-29)
Layers 3, 5, 7, 9, 11, 13, 15, 17, 19, 21, 23, 25, 27: 100% EPC-1 (20% of total thickness of layers 1-29)
Layers 4, 6, 8, 10, 12, 14, 16, 18, 20, 22, 24, 26: 100% LLDPE-1 (20% of total thickness of layers 1-29)
Layer 28: 15% MB-2+40% VLDPE-4+45% LLDPE-1 (18% of total thickness of layers 1-29)
Layer 29: 83% LLDPE-1+17% MB-1 (12% of total thickness of layers 1-29)

### Example 14

A multilayer film was made by the process described above for Example 1, and had the following twenty-nine layer structure with a total film thickness of 0.35 mils:
Layer 1: 83% LLDPE-1+17% MB-1 (12% of total thickness of layers 1-29)
Layer 2: 15% MB-2+40% VLDPE-4+45% LLDPE-1 (18% of total thickness of layers 1-29)
Layers 3, 5, 7, 9, 11, 13, 15, 17, 19, 21, 23, 25, 27: 100% EPC-1 (20% of total thickness of layers 1-29)
Layers 4, 6, 8, 10, 12, 14, 16, 18, 20, 22, 24, 26: 100% EPC-3 (20% of total thickness of layers 1-29)
Layer 28: 15% MB-2+40% VLDPE-4+45% LLDPE-1 (18% of total thickness of layers 1-29)
Layer 29: 83% LLDPE-1+17% MB-1 (12% of total thickness of layers 1-29)

### Example 15

A multilayer film was made by the process described above for Example 1, and had the following twenty-nine layer structure with a total film thickness of 0.35 mils:
Layer 1: 83% LLDPE-1+17% MB-1 (16% of total thickness of layers 1-29)
Layer 2: 61% EPC-1 & 14% MB-2 & 25% LLDPE-1 (16.7% of total thickness of layers 1-29)
Layers 3, 5, 7, 9, 11, 13, 15, 17, 19, 21, 23, 25, 27: 100% EPC-1 (20% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1 & 14% MB-2 & 25% LLDPE-1 (16.7% of total thickness of layers 1-29)
Layer 29: 83% LLDPE-1+17% MB-1 (16% of total thickness of layers 1-29)

### Example 16

A multilayer film in accordance with the present invention was made and had the following twenty nine-layer structure, with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 90% EPC-3+10% EPC-2 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 17

A multilayer film in accordance with the present invention was made and had the following twenty nine-layer structure, with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 70% EPC-3+30% EPC-2 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 18

A multilayer film in accordance with the present invention was made and had the following twenty nine-layer structure, with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 90% EPC-3+10% OBC (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 19

A multilayer film in accordance with the present invention was made and had the following twenty nine-layer structure, with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 20% EPC-3+20% OBC+60% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 20

A multilayer film in accordance with the present invention was made and had the following twenty nine-layer structure, with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 100% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 21

A multilayer film in accordance with the present invention was made and had the following twenty nine-layer structure, with a total film thickness of 0.35 mils:
Layer 1: 83% VLDPE-5+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 40% EPC-3+60% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% VLDPE-5+17% MB-1 (16% of total thickness of layers 1-29)

### Example 22

A multilayer film in accordance with the present invention was made and had the following twenty nine-layer structure, with a total film thickness of 0.35 mils:
Layer 1: 83% LLDPE-1+17% MB-1 (16% of total thickness of layers 1-29)
Layer 2: 61% EPC-1+14% MB-2+25% VLDPE-5 (16.7% of total thickness of layers 1-29)
Layers 3, 5, 7, 9, 11, 13, 15, 17, 19, 21, 23, 25, 27: 30% EPC-3+20% OBC-1+50% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% VLDPE-5 (16.7% of total thickness of layers 1-29)
Layer 29: 83% LLDPE-1+17% MB-1 (16% of total thickness of layers 1-29)

### Example 23

A multilayer film in accordance with the present invention was made and had the following twenty nine-layer structure, with a total film thickness of 0.35 mils:
Layer 1: 83% LLDPE-1+17% MB-1 (16% of total thickness of layers 1-29)
Layer 2: 61% EPC-1+14% MB-2+25% LLDPE-1 (16.7% of total thickness of layers 1-29)
Layers 3, 5, 7, 9, 11, 13, 15, 17, 19, 21, 23, 25, 27: 50% EPC-3+20% OBC+50% EPC-1 (17.3% of total thickness of layers 1-29)
Layers 4, 6, 8, 10, 12, 14, 16, 18, 20, 22, 24, 26: 100% VLDPE-4 (17.3% of total thickness of layers 1-29)
Layer 28: 61% EPC-1+14% MB-2+25% LLDPE-1 (16.7% of total thickness of layers 1-29)
Layer 29: 83% LLDPE-1+17% MB-1 (16% of total thickness of layers 1-29)

### Example 24

A multilayer film in accordance with the present invention was made and had the following twenty nine-layer structure, with a total film thickness of 0.35 mils:
Layer 1: 83% LLDPE-1+17% MB-1 (20.6% of total thickness of layers 1-29)
Layer 2-28: 100% VLDPE-1 (58.8% of total thickness of layers 1-29)
Layer 29: 83% LLDPE-1+17% MB-1 (20.6% of total thickness of layers 1-29)

### Example 25

A multilayer film in accordance with the present invention was made and had the following twenty nine-layer structure, with a total film thickness of 0.35 mils:
Layer 1: 83% LLDPE-1+17% MB-1 (14.7% of total thickness of layers 1-29)
Layer 2-28: 100% VLDPE-3 (70.6% of total thickness of layers 1-29)
Layer 29: 83% LLDPE-1+17% MB-1 (14.7% of total thickness of layers 1-29)

### Example 26

A multilayer film in accordance with the present invention was made and had the following twenty nine-layer structure, with a total film thickness of 0.35 mils:
Layer 1: 83% LLDPE-1+17% MB-1 (14.7% of total thickness of layers 1-29)
Layer 2-28: 100% OBC-1 (70.6% of total thickness of layers 1-29)
Layer 29: 83% LLDPE-1+17% MB-1 (14.7% of total thickness of layers 1-29)

### Example 27

A multilayer film in accordance with the present invention was made and had the following twenty nine-layer structure, with a total film thickness of 0.35 mils:
Layer 1: 83% LLDPE-1+17% MB-1 (14.7% of total thickness of layers 1-29)
Layer 2-28: 100% EPC-1 (70.6% of total thickness of layers 1-29)
Layer 29: 83% LLDPE-1+17% MB-1 (14.7% of total thickness of layers 1-29)

### Example 28

A multilayer film in accordance with the present invention was made and had the following twenty nine-layer structure, with a total film thickness of 0.35 mils:
Layer 1: 83% LLDPE-1+17% MB-1 (14.7% of total thickness of layers 1-29)
Layers 2, 3, 5, 7, 9, 11, 13, 15, 17, 19, 21, 23, 25, 27, 28: EPC-1 (52.9% of total thickness of layers 1-29)
Layers 4, 6, 8, 10, 12, 14, 16, 18, 20, 22, 24, 26: 75% EVA-2+25% LLDPE-1 (17.6% of total thickness of layers 1-29)
Layer 29: 83% LLDPE-1+17% MB-1 (14.7% of total thickness of layers 1-29)

### Example 29

A multilayer film in accordance with the present invention was made and had the following twenty nine-layer structure, with a total film thickness of 0.35 mils:
Layer 1: 83% LLDPE-1+17% MB-1 (14.7% of total thickness of layers 1-29)
Layers 2, 3, 5, 7, 9, 11, 13, 15, 17, 19, 21, 23, 25, 27, 28: EPC-1 (52.9% of total thickness of layers 1-29)
Layers 4, 6, 8, 10, 12, 14, 16, 18, 20, 22, 24, 26: 100% VLDPE-1 (17.6% of total thickness of layers 1-29)
Layer 29: 83% LLDPE-1+17% MB-1 (14.7% of total thickness of layers 1-29)

### Example 30

A multilayer film in accordance with the present invention was made and had the following twenty nine-layer structure, with a total film thickness of 0.35 mils:
Layer 1: 83% LLDPE-1+17% MB-1 (14.7% of total thickness of layers 1-29)
Layers 2, 3, 5, 7, 9, 11, 13, 15, 17, 19, 21, 23, 25, 27, 28: EPC-1 (52.9% of total thickness of layers 1-29)
Layers 4, 6, 8, 10, 12, 14, 16, 18, 20, 22, 24, 26: 100% VLDPE-3 (17.6% of total thickness of layers 1-29)
Layer 29: 83% LLDPE-1+17% MB-1 (14.7% of total thickness of layers 1-29)

### Example 31

A multilayer film in accordance with the present invention was made and had the following twenty nine-layer structure, with a total film thickness of 0.35 mils:
Layer 1: 70% LLDPE-1+30% MB-1 (8% of total thickness of layers 1-29)
Layers 2: 60% EPC-1+15% MB-3+25% VLDPE-5 (17.0% of total thickness of layers 1-29)
Layers 3, 5, 7, 9, 11, 13, 15, 17, 19, 21, 23, 25, 27: 100% EPC-1 (25% of total thickness of layers 1-29)
Layers 4, 6, 8, 10, 12, 14, 16, 18, 20, 22, 24, 26: 100% VLDPE-4 (25% of total thickness of layers 1-29)
Layer 28: 60% EPC-1+15% MB-3+25% VLDPE-5 (17.0% of total thickness of layers 1-29)
Layer 29: 70% LLDPE-1+30% MB-1 (8% of total thickness of layers 1-29)

### Example 32

A multilayer film in accordance with the present invention was made and had the following twenty nine-layer structure, with a total film thickness of 0.35 mils:
Layer 1: 70% LLDPE-1+30% MB-1 (8% of total thickness of layers 1-29)
Layers 2: 60% EPC-1+15% MB-3+25% VLDPE-5 (17.0% of total thickness of layers 1-29)
Layers 3, 5, 7, 9, 11, 13, 15, 17, 19, 21, 23, 25, 27: 50% EPC-1+50% OBC-2 (25% of total thickness of layers 1-29)
Layers 4, 6, 8, 10, 12, 14, 16, 18, 20, 22, 24, 26: 100% VLDPE-4 (25% of total thickness of layers 1-29)
Layer 28: 60% EPC-1+15% MB-3+25% VLDPE-5 (17.0% of total thickness of layers 1-29)
Layer 29: 70% LLDPE-1+30% MB-1 (8% of total thickness of layers 1-29)

### Example 33

A multilayer film in accordance with the present invention was made and had the following twenty nine-layer structure, with a total film thickness of 0.35 mils:
Layer 1: 70% LLDPE-1+30% MB-1 (8% of total thickness of layers 1-29)
Layers 2: 60% EPC-1+15% MB-3+25% VLDPE-5 (17.0% of total thickness of layers 1-29)
Layers 3, 5, 7, 9, 11, 13, 15, 17, 19, 21, 23, 25, 27: 70% EPC-1+30% EPC-5 (25% of total thickness of layers 1-29)
Layers 4, 6, 8, 10, 12, 14, 16, 18, 20, 22, 24, 26: 100% VLDPE-4 (25% of total thickness of I ayers 1-29)
Layer 28: 60% EPC-1+15% MB-3+25% VLDPE-5 (17.0% of total thickness of layers 1-29)
Layer 29: 70% LLDPE-1+30% MB-1 (8% of total thickness of layers 1-29)

### Example 34

A multilayer film in accordance with the present invention was made and had the following twenty nine-layer structure, with a total film thickness of 0.35 mils:
Layer 1: 70% LLDPE-1+30% MB-1 (16% of total thickness of layers 1-29)
Layers 2: 80% EPC-1+20% MB-3 (16.7% of total thickness of layers 1-29)
Layers 3, 5, 7, 9, 11, 13, 15, 17, 19, 21, 23, 25, 27: 50% EPC-1+25% LLDPE-1+25% OBC-2 (17.3% of total thickness of layers 1-29)
Layers 4, 6, 8, 10, 12, 14, 16, 18, 20, 22, 24, 26: 75% EVA-3+25% LLDPE-1 (17.3% of total thickness of layers 1-29)
Layer 28: 80% EPC-1+20% MB-3 (16.7% of total thickness of layers 1-29)
Layer 29: 70% LLDPE-1+30% MB-1 (16% of total thickness of layers 1-29)

### Example 35

A multilayer film in accordance with the present invention was made and had the following twenty nine-layer structure, with a total film thickness of 0.35 mils:
Layer 1: 70% LLDPE-1+30% MB-1 (16% of total thickness of layers 1-29)
Layers 2: 60% EPC-1+15% MB-3+25% LLDPE-1 (16.7% of total thickness of layers 1-29)
Layers 3, 5, 7, 9, 11, 13, 15, 17, 19, 21, 23, 25, 27: 50% EPC-1+25% LLDPE-1+25% OBC-2 (17.3% of total thickness of layers 1-29)
Layers 4, 6, 8, 10, 12, 14, 16, 18, 20, 22, 24, 26: 75% EVA-3+25% LLDPE-1 (17.3% of total thickness of layers 1-29)
Layer 28: 60% EPC-1+15% MB-3+25% LLDPE-1 (16.7% of total thickness of layers 1-29)
Layer 29: 70% LLDPE-1+30% MB-1 (16% of total thickness of layers 1-29)

### Example 36

A multilayer film in accordance with the present invention was made and had the following twenty nine-layer structure, with a total film thickness of 0.35 mils:
Layer 1: 70% LLDPE-1+30% MB-1 (16% of total thickness of layers 1-29)
Layers 2: 60% EPC-1+15% MB-3+25% LLDPE-1 (16.7% of total thickness of layers 1-29)
Layers 3, 5, 7, 9, 11, 13, 15, 17, 19, 21, 23, 25, 27: 50% EPC-1+50% OBC-2 (17.3% of total thickness of layers 1-29)
Layers 4, 6, 8, 10, 12, 14, 16, 18, 20, 22, 24, 26: 80% EPC-3+20% VLDPE-6 (17.3% of total thickness of layers 1-29)
Layer 28: 60% EPC-1+15% MB-3+25% LLDPE-1 (16.7% of total thickness of layers 1-29)
Layer 29: 70% LLDPE-1+30% MB-1 (16% of total thickness of layers 1-29)

### Example 37

A multilayer film in accordance with the present invention was made and had the following 29 layer structure, with a total film thickness of 0.30-0.35 mils:
Layer 1: 70% LLDPE-1+30% MB-1 (18% of total thickness of layers 1-29)
Layer 2: 80% LLDPE-3+20% MB-3 (17% of total thickness of layers 1-29)
Layers 3, 5, 7, 9, 11, 13, 15, 17, 19, 21, 23, 25, 27: 100% COC-1 (13% of total thickness of layers 1-29)
Layers 4, 6, 8, 10, 12, 14, 16, 18, 20, 22, 24, 26: 50% EPC-1+25% OBC-2+25% LLDPE-1 (17% of total thickness of layers 1-29)
Layer 28: 80% LLDPE-3+20% MB-3 (17% of total thickness of layers 1-29)
Layer 29: 70% LLDPE-1+30% MB-1 (18% of total thickness of layers 1-29)
   The films of Examples 1-37 were subjected to the following tests using a Model A26 Shanklin Intermittent Motion Wrapper to convey test packages containing furnace filters, an EASTY manual L-bar heat-seal machine to wrap and seal film over the filters, and a Shanklin T71 heat-shrink tunnel for heat-shrinking the film over the filters:
1. Machinability: ability of the film to be manipulated by the foregoing machinery, including the ability to be wrapped about the filters and trimmed; judged on a scale of 1 to 10, with 1 being poor and 10 being excellent.
2. Survivability: ability of the film to be manipulated by the foregoing machinery without tearing or sagging; judged on a “pass/fail” rating, based on the film's ability to make 10 packages without tearing or sagging.
3. Package Appearance: a subjective evaluation on a scale of 1 to 10 (1=poor and 10=excellent) of the appearance of each finished package after the film was heat-shrunk about the furnace filter in the heat-shrink tunnel; assessed factors include ‘dog ears’ (loose film flap at corner of package), tautness/wrinkling, and clarity/haze.
4. Filter Distortion: evaluation of completed packages (shrink-wrapped furnace filters) at three time intervals:
   A. immediately out of the shrink tunnel;
   B. after aging in a hot box (4 days at 120° F.); and
   C. after further aging at room temperature (5 days at 65-73° F.) while leaning against a vertical surface at an angle (from vertical) of 15-20° angle.
   Evaluation encompassed visual assessment of distortion levels based on angle of twist, bend, side compression (when shrink tension of film compresses the sides of filter such that the normal 90° angles of the filter were distorted), and bowing. Most problematic of these is angle of twist, also known as “warp” or “bowtie” as it gives an appearance of a bowtie shape from a side profile. Filters with a rating of 6 or higher after stage ‘C’ above were considered to be potentially fit for use. This rating system ranged from 1 to 10 is as follows:
      Level 0=45-90° warp
      Level 1=35-45° warp
      Level 2=25-35° warp
      Level 3=15-25° warp
      Level 4=7-15° warp
      Level 5=4-7° warp
      Level 6=2-4° warp
      Level 7=1-3 degree warp (with some side pull allowed)
      Level 8=<2 degree warp with limited to no side pull
      Level 9=<1 degree warp with no side pull and no interior geometry distortion
Level 10=perfection (almost unobtainable; most filters come in the 7-9 range from the manufacturer (prior to being shrink wrapped))
   The results are summarized in Tables 1-7.
The table below shows the calculated % ethylene content of various EPC polymers used to produce the films in this document.

| Resin Code | NMR Calculated % Ethylene* |
|---|---|
| EPC-1 | 12.9% |
| EPC-2 | 12.9% |
| EPC-3 | 3.5% |
| EPC-4 | 4.7 |
| EPC-5 | 6.9% |

*Calculated using NMR in accordance with the method described in the De Pooter et al., “Determination of the Composition of Common Linear Low Density Polyethylene Copolymers by 13C-NMR Spectroscopy, Journal of Applied Polymer Science, 1991, Vol. 42, 399-408.

The calculated % ethylene content values of EPC-1 through EPC-5 were used to calculate the % ethylene from EPC in layers 3, 5, 7, 9, 11, 13, 15, 17, 19, 21, 23, 25, and 27 (“Core 1”), the % ethylene from EPC in layers 4, 6, 8, 10, 12, 14, 16, 18, 20, 22, 24, and 26 (“Core 2”) and the % ethylene from EPC in all layers (total film).

“Calculated Film Density” was calculated by summing the individual contribution of each material in the final film formulation. For instance, if a film is comprised of 70% LLDPE-1 with density of 0.920 g/cc and 30% EPC-1 with density of 0.877 g/cc, the film density is determined by the equation below:

Film density=(0.70/0.920)+(0.30/0.877)=0.907

TABLE 1

| Example # | 1 | 2 | 3 |
|---|---|---|---|
| Calculated film density (g/cc) | 0.907 | 0.907 | 0.905 |
| Machinability | 6 | 5.5 | 4 |
| Survivability | pass | fail | pass |
| Shrink tunnel temperature (° F.) | 214 | 195 | 195 |
| Package appearance | 5 | 6 | 8 |
| filter distortion out of tunnel | 9 | 4 | 8 |
| filter distortion out of hot box | 6 | 7 | 5 |
| filter distortion after room aging | 3.5 | 4 | 3 |
| at 15-20° angle | | | |
| % ethylene from EPC in core 1 | 2.45% | 5.38% | 8.20% |
| % ethylene from EPC in core 2 | 0.00% | 12.90% | 0.00% |
| % ethylene from EPC in total film | 3.00% | 3.50% | 3.99% |

TABLE 2

| Example # | 4 | 5 | 6 | 7 | 8 | 9 |
|---|---|---|---|---|---|---|
| Calculated film density (g/cc) | 0.905 | 0.904 | 0.904 | 0.903 | 0.904 | 0.903 |
| Machinability | 6.5 | 7.5 | 6 | 7 | 5.5 | 6 |
| Survivability | Pass | Pass | Pass | Pass | Pass | Pass |
| Shrink tunnel temperature (° F.) | 195 | 195 | 195 | 195 | 195 | 210 |
| Package appearance | 6 | 5 | 6 | 6.5 | 7 | 7 |
| filter distortion out of tunnel | 7.5 | 8 | 8 | 8 | 7 | 7 |
| filter distortion out of hot box | 6 | 7 | 7 | 5 | 4 | 7 |
| filter distortion after room aging at 15-20° angle | 3 | 5 | 5 | 4 | 3 | 6 |
| % ethylene from EPC in core 1 | 9.14% | 6.32% | 11.02% | 11.96% | 7.50% | 12.90% |
| % ethylene from EPC in core 2 | 0.00% | 0.00% | 0.00% | 0.00% | 0.00% | 0.00% |
| % ethylene from EPC in total film | 4.15% | 4.30% | 4.45% | 4.61% | 3.87% | 5.78% |

TABLE 3

| Example # | 10 | 11 | 12 | 13 | 14 | 15 |
|---|---|---|---|---|---|---|
| Calculated film density (g/cc) | 0.905 | 0.909 | 0.911 | 0.911 | 0.908 | 0.903 |
| Machinability | 6 | 4 | — | — | 6 | 6.5 |
| Survivability | Pass | Fail | — | Pass | Pass | Pass |
| Shrink tunnel temperature (° F.) | 210 | 210 | — | — | 192 | 210 |
| Package appearance | 7 | 7 | — | — | 8 | 6 |
| filter distortion out of tunnel | 7 | 7 | — | — | 8 | 4 |
| filter distortion out of hot box | 7 | 7 | — | — | 5 | 0 |
| filter distortion after room aging at 15-20° angle | 5 | 5 | — | — | 3 | 0 |
| % ethylene from EPC in core 1 | 9.68% | 9.68% | 9.68% | 12.90% | 12.90% | 12.90% |
| % ethylene from EPC in core 2 | 0.00% | 0.00% | 0.00% | 0.00% | 3.50% | 0.00% |
| % ethylene from EPC in total film | 5.25% | 4.22% | 1.63% | 2.48% | 3.19% | 4.76% |

TABLE 4

| Example # | 16 | 17 | 18 | 19 | 20 | 21 |
|---|---|---|---|---|---|---|
| Calculated film density (g/cc) | 0.907 | 0.906 | 0.907 | 0.903 | 0.903 | 0.903 |
| Machinability | 5 | 4 | 3.5 | 8 | 7 | 7 |
| Survivability | Pass | Pass | Pass | Pass | Fail | Pass |
| Shrink Tunnel temperature (° F.) | 210 | 210 | 210 | 190 | 195 | 195 |
| Package appearance | 7 | 8 | 6 | 6 | 4-8 | 6 |
| filter distortion out of tunnel | 9 | 9 | 8 | 9 | 9 | 9 |
| filter distortion out of hot box | 8 | 8 | 7 | 8 | 8.5 | 7 |
| filter distortion after room aging at 15-20° angle | 8 | 6 | 6 | 8 | 8 | 4 |
| % ethylene from EPC in core 1 | 4.44% | 6.32% | 3.15% | 8.44% | 12.90% | 9.14% |
| % ethylene from EPC in core 2 | 0.00% | 0.00% | 0.00% | 0.00% | 0.00% | 0.00% |
| % ethylene from EPC in total film | 2.99% | 3.66% | 3.12% | 3.48% | 4.77% | 4.11% |

TABLE 5

| Example # | 22 | 23 | 24 | 25 | 26 | 27 |
|---|---|---|---|---|---|---|
| Calculated film density (g/cc) | 0.904 | 0.905 | 0.911 | 0.886 | 0.883 | 0.889 |
| Machinability | 5 | 6 | 4 | 3 | 4 | 6 |
| Survivability | fail | fail | Pass | | Fail | |
| Shrink Tunnel temperature (° F.) | 195 | 195 | 195 | 235 | 195 | 195 |
| Package appearance | 6 | 7 | 5 | 3 | 4 | 6 |
| filter distortion out of tunnel | 6-8 | 7 | 6 | 6 | 3 | 5 |
| filter distortion out of hot box | 7 | 7 | | 6 | | |
| filter distortion after room aging at 15-20° angle | 7 | 7 | 4 | 6 | 2 | 3 |
| % ethylene from EPC in core 1 | 7.50% | 5.62% | 0.00% | 0.00% | 0.00% | 12.90% |
| % ethylene from EPC in core 2 | 0.00% | 0.00% | 0.00% | 0.00% | 0.00% | 12.90% |
| % ethylene from EPC in total film | 3.84% | 3.55% | 0.00% | 0.00% | 0.00% | 8.95% |

TABLE 6

| Example # | 28 | 29 | 30 | 31 | 32 |
|---|---|---|---|---|---|
| Calculated film density (g/cc) | 0.899 | 0.894 | 0.889 | 0.898 | 0.898 |
| Machinability | 5 | 5 | 6 | 7 | 7 |
| Survivability | Fail | Fail | Fail | Fail | Pass |
| Shrink Tunnel temperature (° F.) | 235 | 235 | 235 | 195 | 195 |
| Package appearance | 4 | 4.5 | 7 | 4 | 6 |
| Filter distortion out of tunnel | 7 | 4 | 5 | 7 | 7.5 |
| filter distortion out of hot box | 5 | — | 5 | 6.5 | 7.5 |
| filter distortion after room aging | 4 | — | 5 | 4.5 | 7 |
| at 15-20° angle | | | | | |
| % ethylene from EPC in core 1 | 12.90% | 12.90% | 12.90% | 12.90% | 6.45% |
| % ethylene from EPC in core 2 | 0.00% | 0.00% | 0.00% | 0.00% | 0.00% |
| % ethylene from EPC in total film | 6.63% | 6.67% | 6.71% | 5.75% | 4.18% |

TABLE 7

| Example # | 33 | 34 | 35 | 36 | 37 |
|---|---|---|---|---|---|
| Calculated film density (g/cc) | 0.9 | 0.907 | 0.910 | 0.903 | 0.923 |
| Machinability | 8 | 8 | 8 | 8 | 8 |
| Survivability | Pass | Fail | Pass | Pass | Pass |
| Shrink Tunnel temperature (° F.) | 195 | 195 | 195 | 195 | 230 |
| Package appearance | 8 | 7 | 6 | 6 | 7 |
| filter distortion out of tunnel | 8 | 8.5 | 6.5 | 7 | 8 |
| filter distortion out of hot box | 8 | 8 | 6.5 | 6 | 7 |
| filter distortion after room aging | 7 | 7 | 6 | 4 | 6 |
| at 15-20° angle | | | | | |
| % ethylene from EPC in core 1 | 11.10% | 6.45% | 6.45% | 7.74% | 0.00% |
| % ethylene from EPC in core 2 | 0.00% | 0.00% | 0.00% | 0.00% | 6.45% |
| % ethylene from EPC in total film | 5.53% | 4.45% | 3.61% | 4.12% | 0.74% |

While the invention has been described with reference to illustrative examples, those skilled in the art will understand that various modifications may be made to the invention as described without departing from the scope of the claims which follow.

1. A multilayer, heat-shrinkable film, comprising:
a. a bulk layer; and
b. a microlayer section comprising at least ten microlayers,
wherein:
each of the microlayers and the bulk layer have a thickness, the thickness of any of the microlayers being at least half the thickness of the bulk layer;
the film has a film density of less than or equal to 0.911 g/cc; and
the microlayer section comprises a repeating sequence of layers represented by the structure:
A/B,
wherein,
A represents a microlayer comprising a blend of two or more different polymers, at least one of which is polypropylene copolymer, and
B represents a microlayer comprising a polymer or polymer blend having a composition that is different from that of A.

2. The heat-shrinkable film of claim 1, wherein said film has a thickness of less than about 0.7 mil.

3. The heat-shrinkable film according to claim 1, wherein:
said film further includes at least a second bulk layer; and
said microlayer section is positioned between said bulk layers.

4. The heat-shrinkable film according to claim 1, wherein said microlayers each have a thickness ranging from about 0.001 to 0.1 mil.

5. The heat-shrinkable film according to claim 1, wherein the ratio of the thickness of any of said microlayers to the thickness of said bulk layer is at least about 1:3.

6. The heat-shrinkable film according to claim 1, wherein said film has a total free shrink (ASTM D2732-03) of at least about 10% at 200° F.

7. The heat-shrinkable film according to claim 1, wherein said propylene copolymer comprises propylene/ethylene copolymer.

8. The heat-shrinkable film of claim 7, wherein said propylene/ethylene copolymer comprises ethylene in an amount ranging from 1% to 25% by weight.

9. The heat-shrinkable film of claim 7, wherein said propylene/ethylene copolymer comprises ethylene in an amount ranging from 2% to 20% by weight.

10. The heat-shrinkable film of claim 7, wherein said propylene/ethylene copolymer comprises ethylene in an amount ranging from 3% to 15% by weight.

11. A multilayer, heat-shrinkable film, comprising:
a. a bulk layer; and
b. a microlayer section comprising at least ten microlayers,
wherein:
each of the microlayers and the bulk layer have a thickness, the thickness of any of the microlayers being at least half the thickness of the bulk layer;
the film has a film density of less than or equal to 0.940 g/cc; and
the microlayer section comprises a repeating sequence of layers represented by the structure:
A/B,
wherein,
A represents a microlayer comprising cyclic olefin copolymer, and
B represents a microlayer comprising a polymer or polymer blend having a composition that is different from that of A.

12. The heat-shrinkable film of claim 11, wherein said film has a thickness of less than about 0.7 mil.

13. The heat-shrinkable film according to claim 11, wherein:
said film further includes at least a second bulk layer; and
said microlayer section is positioned between said bulk layers.

14. The heat-shrinkable film according to claim 11 wherein said microlayers each have a thickness ranging from about 0.001 to 0.1 mil.

15. The heat-shrinkable film according to claim 11, wherein the ratio of the thickness of any of said microlayers to the thickness of said bulk layer is at least about 1:3.

16. The heat-shrinkable film according to claim 11, wherein said film has a total free shrink (ASTM D2732-03) of at least about 10% at 200° F.
